(19) United States
(12) Patent Application Publication
(10) Pub. No.: US 2023/0072445 A1
(43) Pub. Date: Mar. 9, 2023

(54) SELF-SUPERVISED VIDEO REPRESENTATION LEARNING BY EXPLORING SPATIOTEMPORAL CONTINUITY

(71) Applicant: HUAWEI TECHNOLOGIES CO., LTD., SHENZHEN (CN)

(72) Inventors: Hanwen LIANG, Thornhill (CA); Peng DAI, Markham (CA); Zhixiang CHI, North York (CA); Lizhe CHEN, Markham (CA); Juwei LU, North York (CA)

(73) Assignee: HUAWEI TECHNOLOGIES CO., LTD., SHENZHEN (CN)

(21) Appl. No.: 17/468,224

(22) Filed: Sep. 7, 2021

(51) Int. Cl. G06N 3/08; G06N 3/04; G06K 9/62

(52) U.S. Cl. CPC G06N 3/084; G06N 3/04; G06K 9/6226; G06K 9/6215

(57) ABSTRACT

This disclosure provides a training method and apparatus, and relates to the artificial intelligence field. The method includes feeding a primary video segment, representative of a concatenation of a first and a second nonadjacent video segments obtained from a video source, to a deep learning backbone network. The method further includes embedding, via the deep learning backbone network, the primary video segment into a first feature output. The method further includes providing the first feature output to a first perception network to generate a first set of probability distribution outputs indicating a temporal location of a discontinuous point associated with the primary video segment. The method further includes generating a first loss function based on the first set of probability distribution outputs. The method further includes optimizing the deep learning backbone network, by backpropagation of the first loss function.

### CROSS-REFERENCE TO RELATED APPLICATIONS

This is the first application filed for the present invention.

### FIELD OF THE INVENTION

The present invention pertains to the field of artificial intelligence, and in particular to methods and systems for training a deep learning model.

### BACKGROUND

Deep learning neural networks and other associated models have been shown to be important developments in computer vision technologies. Deep learning models usually rely on large amounts of data arranged in annotated datasets for effective training. For example, ImageNet is used to train image-based tasks such as image classification, object detection, etc. ImageNet is described in Deng et al., “ImageNet: A large-scale hierarchical image database,” 2009 IEEE Conference on Computer Vision and Pattern Recognition, 2009, pp. 248-255, doi: 10.1109/CVPR.2009.5206848. Kinetic400 is used to train video-related tasks such as action recognition, video retrieval, etc. Kinetic400 is described in kay et al., “The Kinetics Human Action Video Dataset,” submitted 19 May 2017, https://arxiv.org/abs/1705.06950, accessed 7 Sep. 2021.

However, data annotation is a time-consuming process that is laborious and expensive. In addition, lack of available annotated datasets adds a further challenge for training deep learning models.

Therefore, there is a need for a method of training deep learning models that obviates or mitigates one or more limitations of the existing solutions.

This background information is provided to reveal information believed by the applicant to be of possible relevance to the present invention. No admission is necessarily intended, nor should be construed, that any of the preceding information constitutes prior art against the present invention.

### SUMMARY

This present disclosure provides methods and apparatus for training a deep learning model in a self-supervised manner. According to a first aspect, a method for training a deep learning model is provided. The method includes feeding a primary video segment, representative of a concatenation of a first and a second nonadjacent video segments obtained from a video source, to a deep learning backbone network. The method further includes embedding, via the deep learning backbone network, the primary video segment into a first feature output. The method further includes providing the first feature output to a first perception network to generate a first set of probability distribution outputs indicating a temporal location of a discontinuous point associated with the primary video segment. The method further includes generating a first loss function based on the first set of probability distribution outputs. The method further includes optimizing the deep learning backbone network, by backpropagation of the first loss function. The method may employ various types of video datasets for training the deep learning backbone network to learn fine-grained motion patterns of videos, in a self-supervised manner, thereby leveraging the massive available unlabelled data and facilitating various downstream video understanding tasks.

In proceeding examples of the first aspect, the method further includes feeding a third video segment, nonadjacent to each of the first video segment and second video segment, obtained from the video source, to the deep learning backbone network. In some embodiments, the method further includes embedding, via the deep learning backbone network, the third video segment into a second feature output. In some embodiments, the method further includes providing the first feature output and the second feature output to a second perception network to generate a second set of probability distribution outputs indicating one or more of a continuity probability and a discontinuity probability associated with the primary and the third video segments. In some embodiments, the method further includes generating a second loss function based on the second set of probability distribution outputs. In some embodiments, the method further includes optimizing the deep learning backbone network, by backpropagation of at least one of the first loss function and the second loss function. The method may provide supervision signals from the one or more video segments themselves (i.e., self-supervised), and promote the deep learning backbone network to learn coarse-grained motion patterns of videos, thereby facilitating various downstream video understanding tasks.

In some examples of the first aspect, the method further includes feeding a fourth video segment, obtained from the video source and temporally adjacent to the first and the second video segments, to the deep learning backbone network. In some embodiments, the method further includes embedding, via the deep learning backbone network, the fourth video segment into a third feature output. In some embodiments, the method further includes providing the first feature output, the second feature output, and the third feature output to a projection network to generate a set of feature embedding outputs. In some embodiments, the set of feature embedding outputs includes a first feature embedding output associated with the primary video segment. In some embodiments, the set of feature embedding outputs further includes a second feature embedding output associated with the third video segment. In some embodiments, the set of feature embedding outputs further includes a third feature embedding output associated with the fourth video segment. In some embodiments, the method further includes generating a third loss function based on the set of feature embedding outputs. In some embodiments, the method further includes optimizing the deep learning backbone network by backpropagation of at least one of the first loss function, the second loss function and the third loss function. The method may further train the deep learning backbone network to learn appearance information of one or more video segments, thereby training the backbone network to learn coarse-grained and fine-grained spatiotemporal representations of videos, which can further facilitate various downstream video understanding tasks.

In some examples of the first aspect, each of the primary video segment and the third video segment is of length n frames, n being an integer equal or greater than two. In some embodiments, the fourth video segment is of length m frames, m being an integer equal or greater than one. In some embodiments, the deep learning backbone network is a 3-dimensional convolution network. In some embodiments, each of the first perception network and the second perception network is a multi-layer perception network. In some embodiments, the projection network is a light-weight convolutional network comprising one or more of: a 3-dimensional convolution layer, an activation layer, and an average pooling layer. In some embodiments, the video source suggests a smooth translation of content and motion across consecutive frames. The smooth translation of content and motion may permit the deep learning backbone network to explore video continuity properties and learn spatiotemporal representations. The method may further be scalable to accommodate a large amounts of video datasets.

In some examples of the first aspect, the first loss function is

$${ℒ}_{l} ( V ; {θ}_{f} , {θ}_{l} ) = - \frac{1}{n} {\sum }_{i}^{n} log \frac{exp ( {L ( {f}_{i , d} )}_{y} )}{{\sum }_{Y} exp ( L ( {f}_{i , d} ) )} .$$

In some embodiments, the second loss functions

$${ℒ}_{j} ( V ; {θ}_{f} , {θ}_{j} ) = - \frac{1}{n} {\sum }_{i}^{n} [ log ( {J ( {f}_{i , d} )}_{y = 0} ) + log ( {J ( {f}_{i , c} )}_{y = 1} ) ] .$$

In some embodiments, the third loss function is

$${ℒ}_{r} ( V ; {θ}_{f} , {θ}_{r} ) = - \frac{1}{n} {\sum }_{i}^{n} [ log \frac{exp ( \frac{sim ( {e}_{i , d} , {e}_{i , c} )}{τ} )}{{\sum }_{j = 0}^{N} exp ( \frac{sim ( {e}_{i , d} , {e}_{j , c} )}{τ} )} + ω * max ( 0 , γ - ( sim ( {e}_{i , d} , {e}_{i , m} ) - sim ( {e}_{i , d} , {e}_{i , c} ) ) ) ] .$$

In some embodiments, V is a set of video sources, wherein the video source is from the set of video sources. In some embodiments, θ_{f} is one or more weight parameters associated with the deep learning backbone network. In some embodiments, θₗ is one or more weight parameters associated with the first perception network. In some embodiments, θⱼ is one or more weight parameters associated with the second perception network. In some embodiments, θᵣ is one or more weight parameters associated with the projection network. In some embodiments, J(fᵢ) represents the second set of probability distribution outputs. In some embodiments, L(fᵢ) represents the first set of probability distribution outputs. In some embodiments, eᵢ represents the set of feature embedding outputs from the projection network. In some embodiments, e_{j,c} represents one feature embedding output of a video segment obtained from a second video source different from the video source. In some embodiments, sim(.,.) represents a similarity score between two feature embedding outputs of the set of feature embedding outputs. In some embodiments, τ, γ and ω are hyper-parameters. The one or more loss functions may optimize the deep learning backbone network by updating the associated weight parameters to learn coarse-grained and fine-grained motion patterns and appearance features of videos, and facilitate the performance of downstream tasks.

According to a second aspect, an apparatus is provided, where the apparatus includes modules configured to perform the methods in the first aspect.

According to a third aspect, an apparatus is provided, where the apparatus includes: a memory, configured to store a program; a processor, configured to execute the program stored in the memory, and when the program stored in the memory is executed, the processor is configured to perform the methods in the first aspect.

According to a fourth aspect, a computer readable medium is provided, where the computer readable medium stores program code executed by a device, and the program code is used to perform the method in the first aspect.

According to a fifth aspect, a computer program product including an instruction is provided. When the computer program product is run on a computer, the computer performs the method in the first aspect.

According to a sixth aspect, a chip is provided, where the chip includes a processor and a data interface, and the processor reads, by using the data interface, an instruction stored in a memory, to perform the method in the first aspect.

Optionally, in an implementation, the chip may further include the memory. The memory stores the instruction, and the processor is configured to execute the instruction stored in the memory. When the instruction is executed, the processor is configured to perform the method in the first aspect.

According to a seventh aspect, an electronic device is provided. The electronic device includes an action recognition apparatus in any one of the second aspect to the fourth aspect.

Other aspects of the disclosure provide for apparatus, and systems configured to implement the methods disclosed herein. For example, wireless stations and access points can be configured with machine readable memory containing instructions, which when executed by the processors of these devices, configures the device to perform the methods disclosed herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates an example of a discontinuous video segment and a missing video segment, in accordance with an embodiment of the present disclosure.

FIG. 2 illustrates a pretext task for training a deep learning model, in accordance with an embodiment of the present disclosure.

FIG. 3 illustrates a continuity learning framework, in accordance with an embodiment of the present disclosure.

FIG. 4 illustrates a discontinuity localization sub-task, in accordance with an embodiment of the present disclosure.

FIG. 5 illustrates a feature space, in accordance with an embodiment of the present disclosure.

FIG. 6 illustrates a procedure for self-supervised learning, in accordance with an embodiment of the present disclosure.

FIG. 7 illustrates a table summarizing related formulas and variables, in accordance with an embodiment of the present disclosure.

FIG. 8 illustrates a method of training a deep learning model, in accordance with an embodiment of the present disclosure.

FIG. 9 illustrates a schematic structural diagram of a system architecture, in accordance with an embodiment of the present disclosure.

FIG. 10 illustrates a convolution neural network (CNN) in accordance with an embodiment of the present disclosure.

FIG. 11 illustrates another convolution neural network (CNN) in accordance with an embodiment of the present disclosure.

FIG. 12 illustrates a schematic diagram of a hardware structure of a chip in accordance with an embodiment of the present disclosure.

FIG. 13 illustrates a schematic diagram of a hardware structure of a training apparatus in accordance with an embodiment of the present disclosure.

FIG. 14 illustrates a schematic diagram of a hardware structure of an execution apparatus in accordance with an embodiment of the present disclosure.

FIG. 15 illustrates a system architecture in accordance with an embodiment of the present disclosure.

It will be noted that throughout the appended drawings, like features are identified by like reference numerals.

### DETAILED DESCRIPTION

A possible solution to training deep learning models is so-called transfer learning, which transfers the learned abundant knowledge from a large dataset to a small annotated dataset. Following similar trend, self-supervised learning, as another alternative, aims to learn the knowledge from annotation-free data. The knowledge may then be transferred to other tasks or domains.

Conventional classic computer vision tasks for images and videos such as, classification, often require learning rich information to improve the generalization. Designing pretext tasks to learn from a large dataset in a self-supervised manner has received great attention. A self-supervised pretext task may refer to a task that has two characteristics: 1) the labels of the task are obtained without human annotation (i.e., label is derived from the data sample itself); 2) the network can learn representative knowledge to improve one or more downstream tasks.

Recent works for self-supervised video representation focus on a certain attribute of videos (e.g., speed or playback rate, arrow of time, temporal order, spatiotemporal statistics, etc.) and perform multiple spatiotemporal transformations to obtain supervision signals. However, these attributes over videos have limitations due to being temporally invariant and coarse-grained. For example, in a given video sample, the speed is constant. This limits a model's potential in extensively exploring the fine-grained features. Embodiments described herein may provide an approach for exploring fine-grained features by targeting an important yet under-explored property of video, namely, ‘video continuity’.

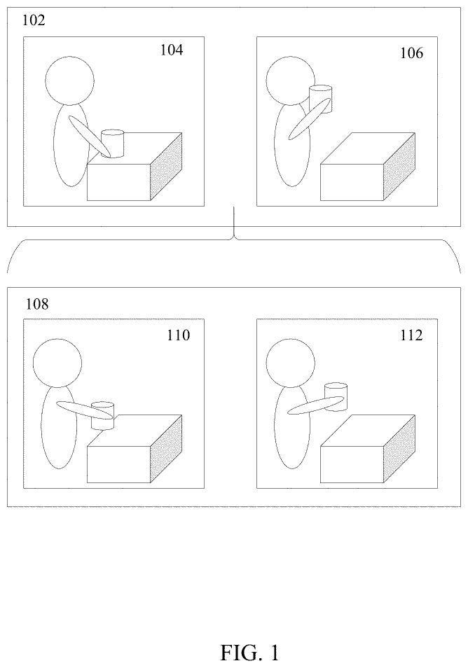

Video continuity suggests the smooth translation of content and motion across consecutive frames. As may be appreciated by a person skilled in the art, cognition science and human vision systems make use of the study of continuity. Humans are able to detect discontinuities in videos and infer high-level semantics associated with the missing segments. For example, referring to FIG. 1, a human can easily infer a missing content, video segment 108, from a discontinuous video 102. FIG. 1 illustrates a discontinuous video segment and a missing video segment, according to an embodiment of the present disclosure. Referring to FIG. 1, a discontinuous video segment 102 comprises two frames 104 and 106. The discontinuous video segment 102 illustrates a person reaching for a coffee mug, in frame 104, and drinking coffee in frame 106. A human can easily determine that the video contains a discontinuity between frames 104 and 106, and can infer the missing content associated with the discontinuity is the lifting of the coffee mug and raising it towards his mouth. Missing frames 110 and 112, show this content associated with the discontinuity. Embodiments described herein may enhance deep models to mimic human vision systems and provide for a pretext task related to video continuity. In mimicking human vision systems, trained deep models may leverage its learned ability to obtain effective video representations for downstream tasks.

As may be appreciated by a person skilled in the art, continuity may be considered an inherent and essential property of a video. Cognition science supports that spatiotemporal continuity may enhance correct and persistent understanding of visual environment. The ability to detect and construct continuity from discontinuous videos may need high-level reasoning and understanding of the way objects move in the world. Enabling, via training, a neural network to leverage such an ability may enhance the model to obtain high-quality spatiotemporal representations of videos, which may be effective in facilitating downstream tasks.

Embodiments described here may provide for a deep learning model that can learn high-quality spatiotemporal representations of videos in a self-supervised manner. Self-supervised manner may refer to learnings in which the model is trained on a set of raw video samples without manual annotations indicating the presence or absence of discontinuities, or where the discontinuities occur in the videos. The learned model can be further adapted to suit multiple downstream video analysis tasks. As may be appreciated by a person skilled in the art, a downstream task is a task that typically has real world applications and human annotated data. Typical downstream tasks in the field of video understanding include action recognition and video retrieval, etc.

To train a deep learning model to learn spatiotemporal representations of videos in a self-supervised manner, embodiments described herein may provide for a pretext task based on video continuity property for the model to carry out. Video continuity, in reference to objects across consecutive frames, may refer to the object being represented as the same persisting individuals over time and motion across consecutive frames.

In an embodiment, the pretext task may involve a discontinuous video clip or video segment, in which the video clip may have an inner portion manually cut-off. Based on the discontinuous video clip, the model is to perform one or more sub-tasks including: justifying or judging whether the video clip is continuous or discontinuous; having justified that the video clip is discontinuous, localizing the discontinuous point by identifying where it is; estimating the missing portion at the discontinuous point.

Embodiments described herein may provide for a pretext task that promote deep learning model to explore video continuity property and learn spatiotemporal representations in the process. The pretext task may comprise one or more sub-tasks: ‘continuity justification’, ‘discontinuity localization’ and ‘missing section estimation’.

Embodiments described herein may relate to a number of neural network applications. For ease of understanding, the following describes relevant concepts of neural networks and relevant terms that are related to the embodiments of this application.

A neural network may comprise a plurality of neural cells. The neural cell may be an operation unit that uses xₛ and an intercept of 1 as inputs. An output from the operation unit may be:

$${h}_{W , b} ( x ) = f ( {W}^{T} x ) = f ( {\sum }_{s = 1}^{n} {W}_{s} {x}_{s} + b ) \qquad ( 1 )$$

where s=1, 2, . . . n, and n is a natural number greater than 1, Wₛ is a weight of xₛ, b is an offset of the neural cell, and f is an activation function (activation functions) of the neural cell and used to introduce a nonlinear feature to the neural network, to convert an input signal of the neural cell to an output signal. The output signal of the activation function may be used as an input to a following convolutional layer. The activation function may be a sigmoid function. The neural network is a network formed by joining a plurality of the foregoing single neural cells. In other words, an output from one neural cell may be an input to another neural cell. An input of each neural cell may be associated with a local receiving area of a previous layer, to extract a feature of the local receiving area. The local receiving area may be an area consisting of several neural cells.

A deep neural network (DNN) is also referred to as a multi-layer neural network and may be understood as a neural network with a plurality of hidden layers. The “plurality” herein does not have a special metric. The DNN is divided according to positions of different layers. The neural networks in the DNN may be classified into three categories: an input layer, a hidden layer, and an output layer. Generally, a first layer is the input layer, a final layer is the output layer, and middle layers are all hidden layers. A full connection between layers refers to adjacent layers in the DNN where each node in one of the layers it connected to each of the nodes in the next layer. A neural cell at an i^{th} layer is connected to any neural cell at an (i+1)^{th} layer.

Briefly, the work at each layer may indicated by the following linear relational expression \vec{y}=α(W\vec{x}+\vec{b}), where \vec{x} is an input vector, \vec{y} is an output vector, \vec{b} is an offset vector, W is a weight matrix (also referred to as a coefficient), and a is an activation function. At each layer, only such a simple operation may be performed on an input vector \vec{x}, to obtain an output vector \vec{y}. Since there may be a large quantity of layers in the DNN, there may also be a large quantity of coefficients W and offset vectors \vec{b}. Definitions of these parameters in the DNN are as follows.

The coefficient W is used as an example. It is assumed that in a three-layer DNN, a linear coefficient from a fourth neural cell at a second layer to a second neural cell at a third layer is defined as W₂₄³. The superscript 3 represents a layer of the coefficient W, and the subscript is corresponding to the output layer-3 index 2 and the input layer-2 index 4. In conclusion, a coefficient from a k^{th} neural cell at an (L−1)^{th} layer to a j^{th} neural cell at an L^{th} layer is defined as Wⱼₖ^{L}. It should be noted that there is no W parameter at the input layer. In the deep neural network, more hidden layers enable a network to depict a complex situation in the real world. In theory, a model with more parameters is more complex, has a larger “capacity”, and indicates that the model can complete a more complex learning task. Training of the deep neural network is a weight matrix learning process. A final purpose of the training is to obtain a trained weight matrix (a weight matrix consisting of weights W of a plurality of layers) of all layers of the deep neural network.

A convolutional neural network (CNN) is a deep neural network with a convolutional structure. The convolutional neural network may include a feature extractor comprising a convolutional layer and a sub-sampling layer. The feature extractor may be considered as a filter. A convolution process may be considered as performing convolution on an input (e.g., image or video) or a convolutional feature map (feature map) by using a trainable filter. The convolutional layer indicates a neural cell layer at which convolution processing is performed on an input signal in the convolutional neural network. At the convolutional layer of the convolutional neural network, one neural cell may be connected only to neural cells at some neighboring layers. One convolutional layer usually includes several feature maps, and each feature map may be formed by some neural cells arranged in a rectangle. Neural cells at a same feature map share a weight. The shared weight herein is a convolutional kernel. The shared weight may be understood as being unrelated to a manner and a position of image information extraction. A hidden principle is that statistical information of a part of an image (or a section of a video) is the same as that of another part. This indicates that image (or video) information learned in a first part may also be used in another part. Therefore, in all positions on the image (or the section of a video), same image (or video) information obtained through same learning may be used. A plurality of convolutional kernels may be used at a same convolutional layer to extract different image information. Generally, a larger quantity of convolutional kernels indicates that richer image (or video) information is reflected by a convolution operation.

A convolutional kernel may be initialized in a form of a matrix of a random size. In a training process of the convolutional neural network, a proper weight may be obtained by performing learning on the convolutional kernel. In addition, a direct advantage brought by the shared weight is that a connection between layers of the convolutional neural network is reduced and a risk of overfitting is lowered.

In the process of training a deep neural network, to enable the deep neural network to output a predicted value that is as close to a truly desired value as possible, a predicted value of a current network and a truly desired target value may be compared, and a weight vector of each layer of the neural network is updated based on a difference between the predicted value and the truly desired target value. There is usually an initialization process before a first update. For example, a parameter may be preconfigured for each layer of the deep neural network. If the predicted value of a network is excessively high, the weight vector may be continuously adjusted to lower the predicted value, until the neural network can predict the truly desired target value. Therefore, an approach to compare the difference between a predicted value and target value may be via a loss function or an objective function. The loss function and the objective function may be used to measure the difference between a predicted value and a target value. For example, the loss function is used as an example. A higher output value (loss) of the loss function indicates a greater difference. In this case, training the deep neural network is a process of minimizing the loss.

In the convolutional neural network, an error back propagation (BP) algorithm may be used in a training process to revise a value of a parameter, e.g., a weight vector, of the network so that a re-setup error loss of the network. An error loss is generated in a process from forward propagation of an input signal to signal output. The parameter of the network is updated through back propagation of error loss information, so that the error loss is converged. The back propagation algorithm is a back propagation movement dominated by an error loss, and is intended to obtain a most optimal network parameter, for example, a weight matrix.

A pixel value of an image or a frame in a video is a long integer indicating a color. It may be a red, green, and blue (RGB) color value, where Blue represents a component of a blue color, Green represents a component of a green color, and Red represents a component of a red color.

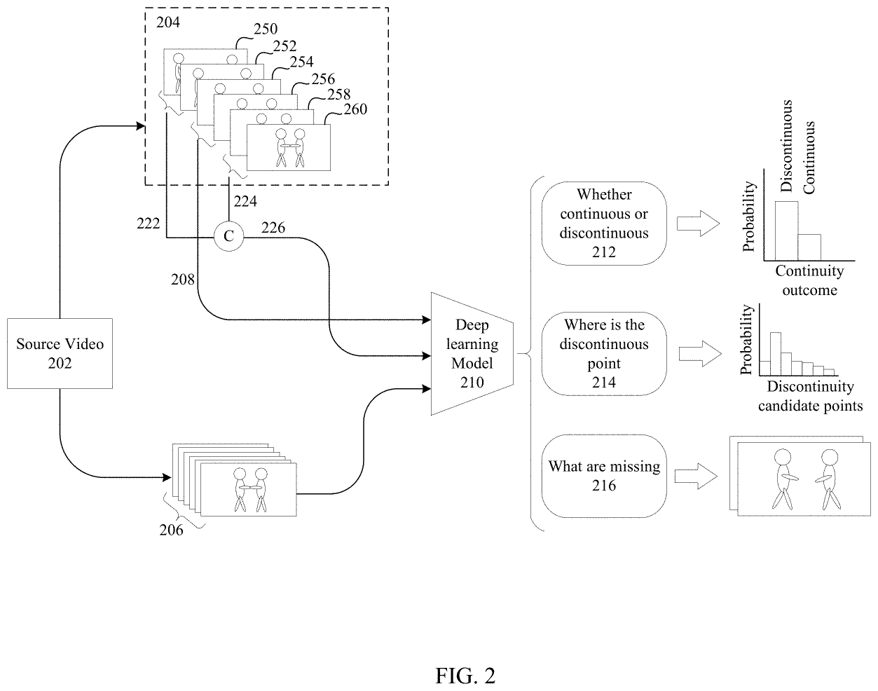

FIG. 2 illustrates a pretext task for training a deep learning model, according to an embodiment of the present disclosure. Referring to FIG. 2, from a source video 202, a first and a second video segments 204 and 206 may be sampled. In the illustrated example, the video segment 204 has 6 frames (250, 252, 254, 256, 258 and 260) along the time dimension. To ensure that the machine learning system has a discontinuous video segment to identify during its training, a portion 208 of the first video segment 204 may be discarded. The portion 208 may be discarded or extracted from video segment 204 along the time dimension. The portion 208 further does not share a boundary with video segment 204. For example, the portion 208 may comprise frames 254 and 256 as illustrated.

Having a portion 208 discarded from the first video segment 204, the remaining portions 222 (comprising frames 250 and 252) and 224 (comprising frames 258 and 260) may be concatenated to obtain a discontinuous video segment 226 as illustrated.

The second video segment 206 is a continuous video segment that is temporally disjoint from the first video segment 204 (the second video segment 206 is nonadjacent to (does not share a boundary with) the video segment 204 (or portions 222, 208 or 224).

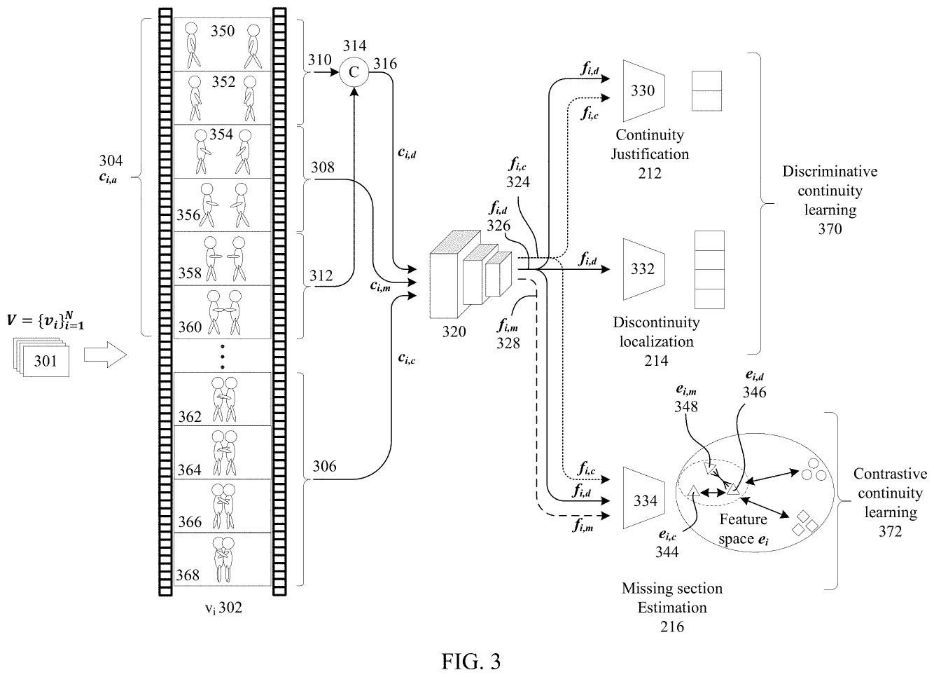

In an embodiment, the discontinuous video segment 226, the missing portion 208, and the continuous video segment 206 may be fed to a processor executing software that enables the training of a software deep learning model 210 so that a processor when executing software associated with the deep learning model 210 perform one or more sub-tasks described herein. It should be understood that in some embodiments model 210 may be a deep learning model. The deep learning model 210 may be configured to perform one or more sub-tasks 212, 214 and 216. Deep learning model 210 in FIG. 2. may refer to the combination of networks 320, 330, 332, and 334 in FIG. 3 as further described herein.

In another embodiment, the discontinuous video segment 226 and the mission portion 208 may be obtained without sampling the video segment 204. For example, video segment 226 may be obtained from concatenation of a first and a second non-adjacent video segments. For example, the first non-adjacent video segment may be portion 222 comprising frames 250 and 252, and the second non-adjacent video segment may be portion 224 comprising frames 258 and 260. And the missing portion 208 may be obtained based on the segment that is temporally adjacent to both the first (e.g., 222) and the second (e.g., 224) video segments. Accordingly, the video segment 204 need not be sampled to obtain the discontinuous video segment 226 and the mission portion 208.

Referring to FIG. 2, the deep learning model 210 may be configured to justify or judge 212 whether one or more of video segment 226 and video segment 206 are continuous or not. The sub-task 212 may involve a global view of temporal consistency of motion across the whole one or more video segments (e.g., 226 and 206). If the deep learning model 210 determines that the video segment, e.g., 226, contains a temporal discontinuity, the deep learning model 210 may then optionally identify the location (e.g., temporal location) of the discontinuity (referred to here as sub-task 214) within the identified discontinuous video segment (e.g., 226). The identification of the location of the discontinuity 214 may comprise the deep learning model 210 localizing where the discontinuity occurs, which may involve a local perception of a dramatic dynamic change along the video stream. After determining the location of the discontinuity 214, the deep learning model 210 may further be configured to estimate 216 what is missing or discarded portion. The estimating 216 may include the model grasping not only the fine-grained motion changes but also the relatively static, temporally-coarse-grained context information in the video segment.

Because discontinuous video segment 226 is created from a known continuous video segment 204, the tagging of the video as containing a discontinuity, and even the identification of the location of the discontinuity are known a priori, and thus can be provided as labels without requiring manual annotations during training. Furthermore, excised content 208 which created the discontinuity can be used in the training of the estimation process 216. In some embodiments, continuous video segment 206 may be a randomly sampled video segment from the same source video 202 and temporally disjoint from video segments 204 and 208. As a result, the output of estimation processor 216 can be compared to video segment 206 to further the refinement of the training in process 216.

A person skilled in the art may appreciate that motion pattern and spatially-rich context information may be considered as complementary aspects for an effective video representation. The integration of these two aspects may be needed for the model to finish the pretext task as described herein. The one or more sub-tasks can jointly optimize the deep learning model, via updating the associated model weights through backpropagation, so that it not only grasps the motion but also obtains the appearance feature of the videos.

Embodiments may enable the self-generation of supervision signals from a video data set and thereby save the labor and costs required for manually annotating the video data set.

Embodiments described herein may provide for a continuity learning framework, illustrated in FIG. 3, to carry out the continuity perception pretext task. FIG. 3 illustrates a continuity learning framework, according to an embodiment of the present disclosure. The details of the framework and training strategy that may be used in one disclosed embodiment are described below.

In an embodiment, V={νᵢ}ᵢ₌₁^{N} may represent a set of N videos or video sources, 301. For each video νᵢ 302, a video segment c_{i,a} 304 with length n+m (defined as a number of frames) may be sampled from the video νᵢ 302. n may be any integer number of frames equal or bigger than two. m may be any integer number of frames equal or bigger than one. In the illustrated example, length (n+m) of c_{i,a} 304 may be 6 (frames 350, 352, 354, 356, 358, 360).

Further, a discontinuous starting-point, k, in the video segment c_{i,a} 304 may be selected, between 1 (representing the first frame of the video segment c_{i,a} 304) and n−1 (representing (n−1)^{th} frame of the video segment c_{i,a} 304), wherein k may represent the k^{th} frame of the video segment c_{i,a} 304 and the starting frame or the first frame of the missing video segment c_{i,m} 308. From video segment c_{i,a} 304, a continuous portion comprising k^{th} frame, 354, to (k+m−1)^{th} frame, 356, may be extracted to obtain the missing video segment c_{i,m} 308. Accordingly, the missing video segment c_{i,m} 308 may have a length m.

The remaining portions of the video segment c_{i,a}, (i.e., frames before k^{th} frame, 310 (comprising frames 350 and 352), and after (k+m−1)th frame, 312 (comprising frames 358 and 360) may be concatenated 314 together to obtain a discontinuous video segment CO, 316. Accordingly, the discontinuous video segment c_{i,d} 316 may have a length n. The discontinuous video segment c_{i,d} 316 may temporally encircle the missing video segment c_{i,m} 308.

In another embodiment, video segments c_{i,d} 316 and c_{i,m} 308 may be obtained without sampling the video segment c_{i,a} 304. For example, video segment c_{i,d} 316 may be obtained from concatenation of a first and a second non-adjacent video segments (e.g., 310 and 312) of a video source νᵢ 302. And video segment c_{i,m} 308 may be obtained based on the segment that is temporally adjacent to both the first (e.g., 310) and the second (e.g., 312) video segments. Accordingly, the video segment c_{i,a} 304 need not be sampled to obtain c_{i,d} 316 and c_{i,m} 308.

In some embodiments, a continuous video segment c_{i,c} 306, with length n and temporally disjoint from video segment c_{i,a} 304, may be sampled from video νᵢ 302. Thus, the continuous video segment c_{i,c} 306 is nonadjacent to (does not share a boundary with) each of the segments 310 and 312. In an embodiment, length of c_{i,c} 306 (n) may be 4 (frames 362, 364, 366 and 368) as illustrated.

As may be appreciated by a person skilled in the art, the video lengths (in number of frames) of the one or more video segments including c_{i,d} 316, c_{i,m} 308, and c_{i,c} 306 is not limited to the illustrated lengths. Rather, in other embodiments, other appropriate video lengths in frames may be used for the video segments c_{i,d}, c_{i,m}, and c_{i,c}.

One or more of the video segments c_{i,d} 316, c_{i,m} 308, and c_{i,c} 306 may be fed into a deep learning backbone, F(cᵢ; θ_{f}) 320 (which corresponds to a part of the deep learning model 210 of FIG. 2). As may be appreciated by a person skilled in the art, the variable cᵢ may represent one or more inputs to the deep learning backbone, and θ_{f} may represent one or more parameters associated with the backbone network 320. The deep learning backbone F(cᵢ; θ_{f}) 320 may be composed of a series of convolutional layers. As may be appreciated by a person skilled in the art, deep learning backbone F(cᵢ; θ_{f}) 320 could be any 3-dimensional (3D) convolutional network.

The deep learning backbone F(cᵢ; θ_{f}) 320 may embed the one or more input video segments c_{i,d} 316, c_{i,m} 308, and c_{i,c} 306 into one or more corresponding feature outputs f_{i,d} 326, f_{i,m} 328 and, f_{i,c} 324 respectively. In FIG. 3, the feature output f_{i,d} 326 is illustrated via solid line, the feature output f_{i,m} 328 is illustrated via dashed line, and feature output f_{i,c} 324 is illustrated via dotted line.

In an embodiment, the feature output f_{i,d} 326 may be fed into a first perception network L(.; θₗ) 332, which may also be a multi-layer perception (MLP) network. The first perception network L(.; θₗ) 332 may perform, using the feature output f_{i,d} 326, a discontinuity localization sub-task 214. The first perception network L(.; θₗ) 332 may generate a first set of probability distribution outputs indicating a location of a discontinuous point associated with the discontinuous video segment c_{i,d} 316. The location of the discontinuous point may be a temporal location for example.

In an embodiment, the feature outputs, e.g., f_{i,d} 326 and f_{i,c} 324 may be fed into a second perception network J(.; θⱼ) 330, which may be a MLP network. θⱼ may represent one or more parameters associated with the second perception network. In an embodiment the second perception network J(.; θⱼ) 330 may be constructed by one or two linear transformation layers. The second perception network J(.; θⱼ) 330 may perform, using the feature outputs e.g., f_{i,d} 326 and f_{i,c} 324, a continuity justification 212 sub-task comprising a binary classification (whether the video segment c_{i,d} 316 is continuous or not). The second perception network J(.; θⱼ) 330 may generate a second set of probability distribution outputs indicating whether the video segments c_{i,d} 316 and c_{i,c} 306 are discontinuous or not. f_{i,d} and f_{i,c} are distinct feature representations. The second perception network J(.; θⱼ) 330 may use f_{i,d} 326 to determine if c_{i,d}316 is continuous or not. The second perception network J(.; θⱼ) 330 may use f_{i,c} 324 to determine if c_{i,c} 306 is continuous or not.

In some embodiments, the discontinuity localization 214 sub-task may be performed if the continuity justification 212 sub-task indicates a discontinuous video segment.

In some embodiments, the one or more feature outputs f_{i,d} 326, f_{i,m} 328 and, f_{i,c} 324 may be fed into a projection network R(.; θᵣ) 334. The projection network R(.; θᵣ) 334 may be a light-weight convolutional network, which may comprise one or more of: a 3-dimensional convolution layer, an activation layer, and an average pooling layer.

The projection network R(.; θᵣ) 334 may perform, using the one or more feature outputs f_{i,d} 326, f_{i,m} 328 and, f_{i,c} 324, the missing section estimation 216 sub-task. The projection network R(.; θᵣ) 334 may generate a set of feature embedding outputs comprising: one or more of e_{i,d} 346, e_{i,m} 348, and e_{i,c} 344, corresponding to the video segments c_{i,d} 316, c_{i,m} 308, and c_{i,c} 306 respectively. The missing section estimation 216 sub-task may further comprise estimating the features of the missing video segment c_{i,m} 308, which may involve using InfoNCE loss and triplet loss as further described herein. InfoNCE is described in Oord et al., “Representation Learning with Contrastive Predictive Coding,” submitted 10 Jul. 2018, https://arxiv.org/abs/1807.03748, accessed 7 Sep. 2021. Triplet loss is described in Schroff et al., “FaceNet: A Unified Embedding for Face Recognition and Clustering,” submitted 12 Mar. 2015, https://arxiv.org/abs/1503.03832, accessed 7 Sep. 2021.

Accordingly, as described, embodiments may provide for using a first (i.e., L(.; θₗ) 332) and a second (i.e., J(.; θⱼ) 330) perception networks, and a projection network R(.; θᵣ) 334 on top of the feature outputs f_{i,d} 326, f_{i,m} 328 and, f_{i,c} 324.

As may be appreciated by a person skilled in the art, the labels for the pretext task, comprising one or more sub-tasks including 212, 214 and 216, may be generated based on the strategy for sampling the video segments c_{i,d} 316, c_{i,m} 308, and c_{i,c} 306, without human annotation, as described herein. The labels obtained from the one or more sub-tasks may be determined from the video segments themselves, thereby providing for a self-supervised video learning method.

As discussed, the deep learning backbone F(cᵢ; θ_{f}) 320, in combination with one of the second perception network (i.e., J(.; θⱼ) 330), the first perception network (i.e., L(.; θₗ) 332) and the projection network R(.; θᵣ) 334 perform the sub-tasks 212, 214 and 216. The backbone 320 and the network 330 perform the continuity justification sub-task 212. The backbone 320 and the network 332 perform the discontinuity localization sub-task 214. And the backbone 320 and the network 334 perform the missing section estimation sub-task 216. As such, the deep learning backbone 320 may be associated with each of the networks 330, 332, and 334, such that the losses at the end of each network 330, 332, and 334 may be back propagated to the deep learning backbone 320 (thereby optimizing, via updating the associated weights of the backbone 320). Accordingly, the deep learning backbone F(cᵢ; θ_{f}) 320 may be trained, in a self-supervised manner, via the performance of the one or more sub-tasks 212, 214, and 216.

The continuity learning framework of FIG. 3 may be viewed as comprising a discriminative continuity learning portion 370 and a contrastive continuity learning portion 372. The joint discriminative-contrastive continuity learning may collaboratively promote the model to learn local-global motion patterns and fine-grained context information in the process.

The discriminative continuity learning portion 370 may be responsible for performing the continuity justification sub-task (corresponding to sub-task 212 of FIG. 2). As may be appreciated by a person skilled in the art, designing classification tasks with cross-entropy loss to update the model weights is a form of discriminative learning. The discriminative continuity learning portion 370 may further be responsible for performing the discontinuous point location sub-task (which corresponds to sub-task 214 of FIG. 2). As illustrated, these two sub-tasks 212 and 214, share a deep learning backbone F(cᵢ; θ_{f}) 320 with separate MLP heads, respectively 330 and 332.

As may be appreciated by a person skilled in the art, a binary cross-entropy loss [symbol] ⱼ(V; θ_{f}, θⱼ), associated with the second perception network J(.; θⱼ) 330, and a general cross-entropy loss [symbol] ₗ(V; θ_{f}, θₗ), associated with the first perception network L(.; θₗ) 332, may be used for optimizing the model 320. The combination of two losses drives the network to perceive the local-global motion patterns of the video sequence.

The binary cross-entropy loss [symbol] ⱼ(V; θ_{f}, θⱼ) may be represented as follows:

$${ℒ}_{j} ( V ; {θ}_{f} , {θ}_{j} ) = - \frac{1}{n} {\sum }_{i}^{n} [ log ( {J ( {f}_{i , d} )}_{y = 0} ) + log ( {J ( {f}_{i , c} )}_{y = 1} ) ] \qquad ( 2 )$$

where, J(fᵢ) is the output from the second perception network J(.; θⱼ) 330, which is the second set of probability distribution indicating whether the video segments are discontinuous or continuous; θⱼ is one or more weight parameters associated with the second perception network 330; V is a set of video sources 301, wherein the video source is from the set of video sources; θ_{f} is one or more weight parameters associated with the deep learning backbone network 320.

The general cross-entropy loss [symbol] ₗ(V; θ_{f}, θₗ) may be represented as follows:

$${ℒ}_{l} ( V ; {θ}_{f} , {θ}_{l} ) = - \frac{1}{n} {\sum }_{i}^{n} log \frac{exp ( {L ( {f}_{i , d} )}_{y} )}{{\sum }_{Y} exp ( L ( {f}_{i , d} ) )} \qquad ( 3 )$$

where L(fᵢ) is the output from the first perception network L(.; θₗ), which is the first set of probability distribution indicating a temporal location of a discontinuous point; θₗ is one or more weight parameters associated with the first perception network.

The contrastive continuity learning portion 372 may be responsible for sub-task 216, which comprises approximating the feature representation of the missing portion (e.g., c_{i,m} 308) in feature space. Given the discontinuous video segment c_{i,d} 316 as anchor, in an embodiment, a vanilla context-based contrastive learning is employed. Vanilla context-based contrastive learning is described in Wang et al., “Self-supervised Video Representation Learning by Pace Prediction,” submitted 10 Jul. 2018, https://arxiv.org/abs/2008.05861, accessed 7 Sep. 2021.

In vanilla context-based contrastive learning, video segments from different videos (C={cⱼ}_{i≠j}) (videos referring to different video sources from the set of N videos (V={νᵢ}ᵢ₌₁^{N})) are taken as a negative set, and a random video segment, e.g., c_{i,c} 306, from the same video (e.g., νᵢ 302) is taken as a positive pair.

As may be appreciated by a person skilled in the art, under contrastive learning setting, an anchor, a positive set and a negative set may be defined. The anchor and a case from the positive set may be called a positive pair. The anchor and a case from the negative set may be called a negative pair.

Accordingly, InfoNCE loss may be used for model optimization, as may be appreciated by a person skilled in the art.

In some embodiments, to further exploit the variance within a video, a triplet loss may be employed. Accordingly, the discontinuous video segment (e.g., c_{i,d} 316) may be taken as anchor, its inner missing portion (e.g., c_{i,m} 308) may be taken as a positive sample, and a random video segment from the save video may be taken as a negative sample. Since the discontinuous video segment may be temporally closer to its inner missing portion, the feature representation of the discontinued video segment is likely to be more similar to the feature representation of the inner missing portion, than the features of the random video segment.

The contrastive loss, which may comprise InfoNCE loss and triplet loss may be represented as follows:

$${ℒ}_{r} ( V ; {θ}_{f} , {θ}_{r} ) = - \frac{1}{n} {\sum }_{i = 0}^{N} [ log \frac{exp ( \frac{sim ( {e}_{i , d} , {e}_{i , c} )}{τ} )}{{\sum }_{j = 0 , i \neq j}^{N} exp ( \frac{sim ( {e}_{i , d} , {e}_{j , c} )}{τ} )} + ω * max ( 0 , γ - ( sim ( {e}_{i , d} , {e}_{i , m} ) - sim ( {e}_{i , d} , {e}_{i , c} ) ) ) ] \qquad ( 4 )$$

where θᵣ is one or more weight parameters associated with the projection network R(.; θᵣ) 334; sim(.,.) is cosine similarity (represents a similarity score between two feature embedding outputs); e_{i,d}, e_{i,m}, e_{i,c}, e_{j,c} are feature embedding outputs generated by the projection network R(.; θᵣ) 334; and τ, γ and ω are hyper-parameters. e_{j,c} may refer to a feature embedding output of a video segment (e.g., a continuous video segment) that is sampled from a video source different from νᵢ.

Accordingly, the total loss for the continuity learning framework may be formulated as follows:

[symbol]

(V;θ_{f},θⱼ,θₗ,θᵣ)= [symbol] ⱼ(V;θ_{f},θⱼ)+α [symbol] ₗ(V;θ_{f},θₗ)+β [symbol] ᵣ(V;θ_{f},θᵣ) (5)

where α and β are two positive hyper-parameters that control the weights of losses.

As may be appreciated by a person skilled in the art, the one or more losses [symbol] ⱼ, [symbol] ₗ, and [symbol] ᵣ as described herein, may be used for backpropagation operations to update the model parameters. Thus, weights may be determined for the model based on the updated parameters, and the determined weights may be maintained for performing downstream tasks.

The self-supervised learning framework, as described herein, may provide for a checkpoint of a deep learning model with trained parameters that may be used for downstream tasks (action classification, video retrieval, etc.).

The continuity learning framework as described herein may provide for learning high-quality spatiotemporal representation via performing one or more sub-tasks as described herein. The design of the one or more sub-tasks in combination with the contrastive continuity learning portion 372 may enhance the deep learning model to learn fine-grained feature representation of a set of videos, which may facilitate multiple downstream video understanding tasks.

Embodiments described herein may provide for a self-supervised learning mechanism that may be scalable for a large amount of video set. The described self-supervised learning mechanism may not be subject to strict requirements on natural video set, and thus, the mechanism may be leveraged to use a variety of video sets. Embodiments described may further enhance model representation capability by leveraging the massive unlabeled data.

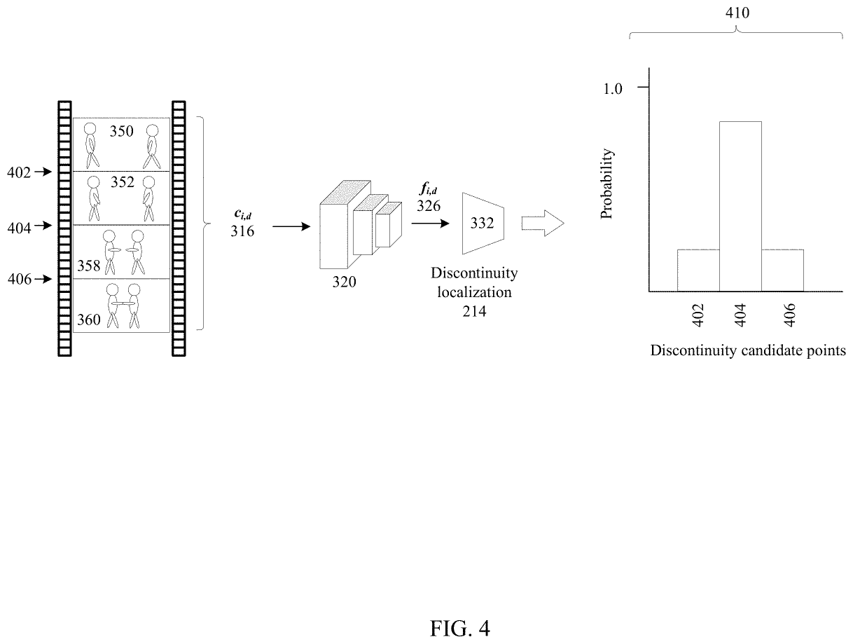

FIG. 4 illustrates a discontinuity localization sub-task, according to an embodiment of the present disclosure. As mentioned in reference to FIG. 3, the discontinuous video segment c_{i,d} 316 of video νᵢ 302 may be fed into the deep learning backbone F(cᵢ; θ_{f}) 320 to generate a corresponding feature output f_{i,d} 326. The feature output f_{i,d} 326 may further be fed into the first perception network L(.; θₗ) 332. The first perception network L(.; θₗ) 332 may generate the first set of probability distribution outputs 410 indicating a temporal location of a discontinuous point associated with the discontinuous video segment c_{i,d} 316.

Referring to FIG. 4, the discontinuous video segment c_{i,d} 316, in an embodiment, may comprise 4 frames (350, 352, 358 and 360), which corresponds to n length (further corresponding to having the missing video segment c_{i,m} 308 removed from the video segment c_{i,a} 304). Accordingly, there may be n−1 (e.g., three) potential or candidate discontinuity points associated with the discontinuous video segment c_{i,d} 316. A first candidate discontinuity point may be at 402 referring to a discontinuity between frame 350 and frame 352. A second candidate discontinuity point may be at 404 referring to a discontinuity between frame 352 and frame 358. A third candidate discontinuity point may be at 406 referring to a discontinuity between frame 358 and frame 360.

Since, the discontinuous video segment c_{i,d} 316 may have a length of n, then there may be n−1 candidate discontinuity points associated with the discontinuous video segment c_{i,d}316. Accordingly, the discontinuity location 214 sub-task may be a n−1 classification problem.

Accordingly, the first perception network L(.; θₗ) 332 may generate the first set of probability distribution outputs 410 indicating a temporal location of a discontinuous point associated with the discontinuous video segment c_{i,d} 316. In an embodiment, the first set of probability distribution outputs 410 may indicate that the discontinuous point associated with the discontinuous video segment c_{i,d} 316 may at the candidate point 404, indicating a discontinuity between frame 352 and 358.

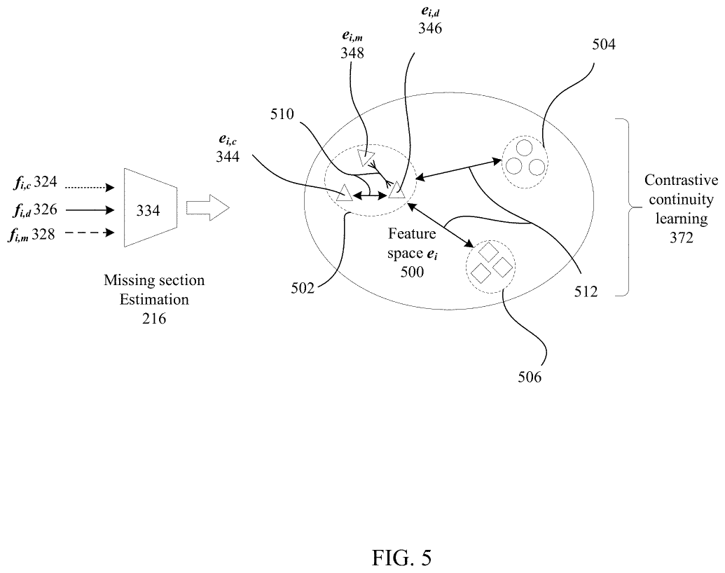

FIG. 5 illustrates a feature space, according to an embodiment of the present disclosure. As discussed in reference to FIG. 3, the contrastive continuity learning portion 372 may be responsible for performing the missing section estimation 216 sub-task to obtain feature embedding outputs within a feature space 500.

Accordingly, the feature space 500 may comprise, for each νᵢ 302 of the V={νᵢ}ᵢ₌₁^{N}, one or more feature embedding outputs (e.g., e_{i,d} 346, e_{i,m} 348, and e_{i,c} 344) corresponding to the one or more video segments inputs (e.g., c_{i,d} 316, c_{i,m} 308, and c_{i,c} 306) to the deep learning backbone F(cᵢ; θ_{f}) 320. Thus, the feature space 500 may comprise N groups of one or more feature embedding outputs, each group associated with a respective video of the V={νᵢ}ᵢ₌₁^{N}. As illustrated, the one or more feature embedding outputs of a group associated with a respective νᵢ 302 may be grouped together within the feature space. As illustrated, the one or more feature embedding outputs of group 502, corresponding to νᵢ 302 (e.g., ν₁), may be grouped together. Further, the different groups of one or more feature embedding outputs, each group being associated with a different respective video of V={νᵢ}ᵢ₌₁^{N}, may be further away from each other. For example, the feature embedding outputs group 504 may correspond to a different video (e.g., ν₂) than the video corresponding to the feature embedding outputs group 502, and thus the group 504 may be further away from group 502 within the feature space 500. Similarly, feature embedding outputs group 506 may correspond to another video, e.g., ν₃, different from ν₂ and ν₁, and thus group 506 may be further away from group 502 and 504 within the feature space 500, as illustrated.

As may be appreciated by a person skilled in the art, to minimize the error, e.g., InfoNCE loss, associated with the contrastive continuity learning 372, the distance, e.g., 510, between the feature embedding outputs within a group, may be minimized, while the distance, e.g., 512, between the different feature embedding outputs groups may be maximized.

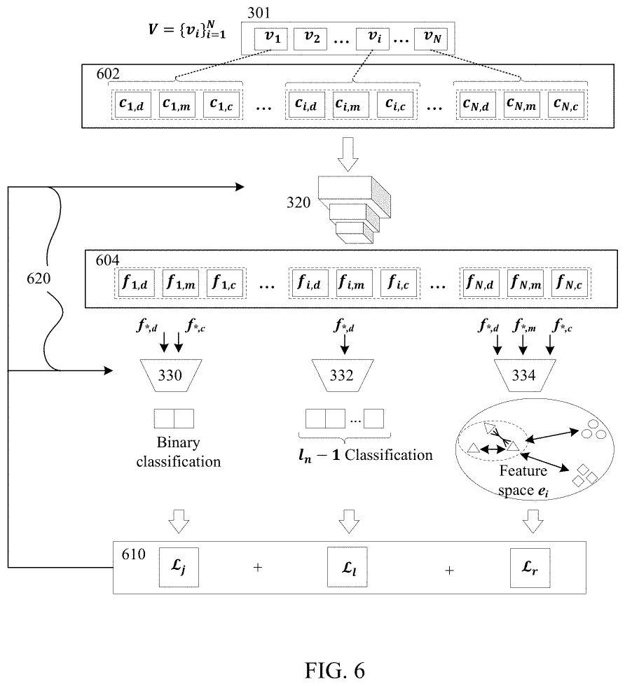

FIG. 6 illustrates a procedure for self-supervised learning, according to an embodiment of the present disclosure.

For each video of a first set of videos V 301, wherein V={νᵢ}ᵢ₌₁^{N}, a set of video segments may be obtained, namely, a discontinuous video segment c_{i,d}, a missing video segment c_{i,m}, and a continuous video segment c_{i,c}. The three video segments may be obtained according to embodiments described herein, for example, embodiments in reference to FIG. 3. Accordingly, N sets of video segments 602 may be obtained. The N set of video segments 602 may be fed into a deep learning backbone, F(cᵢ; θ_{f}) 320, to generate a set of feature outputs 604, wherein each output may comprise a set of features representations corresponding to a different set of video segments 602.

In some embodiments, for each video νᵢ, the feature output corresponding to the discontinuous video segment f_{*,d} may be fed into the first perception network 332 to perform the sub-task 214 comprising an lₙ−1 classification problem as described herein.

In some embodiments, for each video νᵢ, the feature outputs corresponding to the discontinuous video segment f_{*,d} and the continuous video segment f_{*,c} with may be fed into a second perception network 330 to perform the sub-task 212 comprising a binary classification problem as described herein.

In some embodiments, the for each video νᵢ, the feature output corresponding to the discontinuous video segment f_{*,d}, the continuous video segment f_{*,c}, and the missing video segment f_{*,m} may be fed into the projection network 334 to perform the sub-task 216 as described herein.

Corresponding errors associated with the sub-task 212, [symbol] ⱼ, with the sub-task 214, [symbol] ₗ, and the sub-task 216, [symbol] ᵣ, may be determined 610. The determined errors may collaboratively be used to update 620, via backpropagation, the parameters of the one or more of the deep learning backbone 320, the first perception network 332, the second perception network 330, and the projection network 334.

The procedure may then begin a second iteration with a second set of videos. The second iteration may follow similar to the procedure described in reference to FIG. 6. As may be appreciated by a person skilled in the art, each iteration of the procedure may be performed in appropriate batch sizes of N.

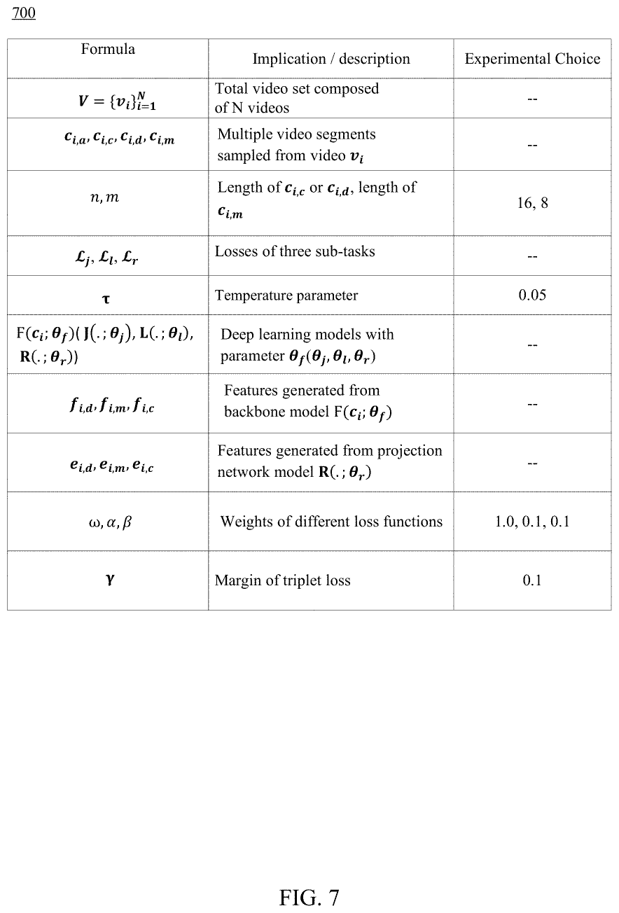

FIG. 7 illustrates a table summarizing related formulas and variables, according to an embodiment of the present disclosure. Table 700 summarizes the various formulas and variables discussed herein, and experimental values used in some embodiments. In some embodiments, experimental values assigned to video segment lengths n and m were 16 and 8 respectively. Accordingly, based on the experimental value of n being 16, the discontinuity localization sub-task 212 would have been an n−1=15 classification problem.

In some embodiments, the experimental value assigned for the temperature parameter τ was 0.05. In some embodiments, the experimental values assigned to weights of different loss functions, ω, α, and β were 1.0, 0.1, and 0.1 respectively. In some embodiments, the experimental value assigned to the margin of triplet loss was 0.1.

Embodiments may provide for a self-supervised video representation learning method by exploring spatiotemporal continuity. Embodiments may further provide for a pretext task that is designed to explore video continuity property. The pretext task may comprise one or more sub-tasks including continuity justification 212, discontinuity localization 214 and missing section estimation 216 as described herein. The continuity justification sub-task 212 may comprise justifying whether a video segment is discontinuous or not. The discontinuity localization sub-task 214 may comprise localizing the discontinuous point in a determined discontinuous video segment. In some embodiments, the discontinuity localization sub-task 214 may be performed after determining, according to the continuity justification sub-task 212, that a video segment is discontinuous. The missing section estimation sub-task 216 may comprise estimating the missing content at the discontinuous point. In some embodiments, the missing section estimation sub-task 216 may be performed after performing one or more of continuity justification sub-task 212 and discontinuity localization sub-task 214.

Embodiments described herein may further provide for a continuity learning framework to solve continuity perception tasks and learn spatiotemporal representations of one or more video in the process. Embodiments described herein may further provide for a discriminative continuity learning portion 370 that is responsible for the continuity justification sub-task 212 and the discontinuity localization sub-task 214. Embodiments described herein may further provide for a contrastive learning portion 372 that is responsible for missing section estimation sub-task 216 (estimating the missing section in feature space 500).

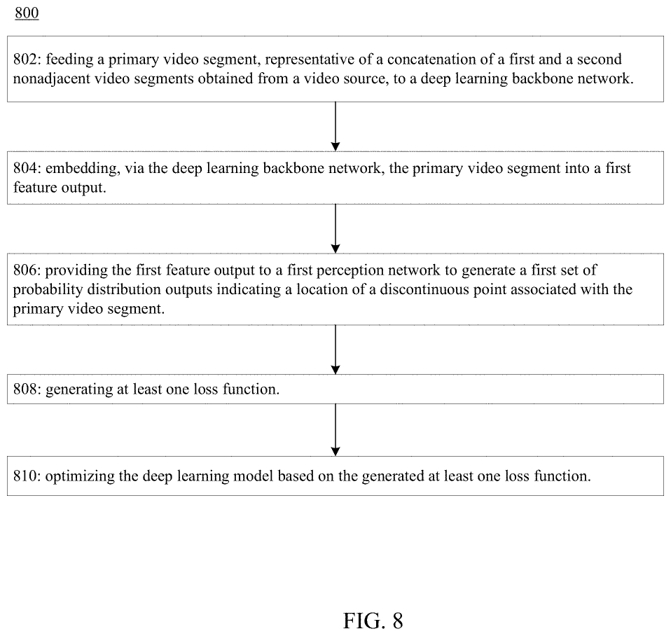

FIG. 8 illustrates a method of training a deep learning model, according to an embodiment of the present disclosure. In an embodiment, the method 800 may comprise, at 802, feeding a primary video segment, representative of a concatenation of a first and a second nonadjacent video segments obtained from a video source, to a deep learning backbone network e.g., backbone 320. The primary video segment may refer to, for example, c_{i,d} 316; the first and the second video segment may refer to 310 and 312. In some embodiments, the video source may refer to a video νᵢ 302 of a set of videos V 301 as described herein.

The method may further comprise at 804, embedding, via the deep learning backbone network, the primary video segment into a first feature output (e.g., f_{i,d} 326).

The method 800 may further comprise, at 806, providing the first feature output to a first perception network, e.g., perception network 332, to generate a first set of probability distribution outputs indicating a location of a discontinuous point associated with the primary video segment. In some embodiments the location of the discontinuous point may be a temporal location. The method may further comprise, at 808, generating at least one loss function. In some embodiments, the at least one loss function may comprise a first loss function based on the first set of probability distribution outputs. The method may further comprise at 810, optimizing the deep learning model based on the generated at least one loss function. In embodiments, the optimizing is based on backpropagation in accordance with the generated at least one loss function.

In some embodiments, the method 800 may further comprise feeding a third video segment, nonadjacent to each of the first video segment and second video segment, obtained from the video source, to the deep learning backbone network. The third video segment may refer to c_{i,c} 306. In some embodiments, the method 800 may further comprise embedding, via the deep learning backbone network, the third video segment into a second feature output (e.g., f_{i,c} 324). In some embodiments, the method 800 may further comprise providing the first feature output and the second feature output to a second perception network e.g., perception network 330, to generate a second set of probability distribution outputs indicating one or more of a continuity probability and a discontinuity probability associated with the primary and the third video segments. In some embodiments, the method 800 may further comprise generating a second loss function based on the second set of probability distribution outputs.

In some embodiments, the method 800 may further comprise feeding a fourth video segment, obtained from the video source and temporally adjacent to the first and the second video segments, to the deep learning backbone network, e.g., backbone 320. The fourth video segment may refer to c_{i,m} 308. In some embodiments, the method 800 may further comprise embedding, via the deep learning backbone network, the fourth video segment into a third feature output (e.g., f_{i,m} 328). In some embodiments, the method 800 may further comprise providing the first feature output, the second feature output, and the third feature output to a projection network to generate a set of feature embedding outputs (e.g., e_{i,d} 346, e_{i,m} 348, and e_{i,c} 344). In some embodiments, the method 800 may further comprise generating a third loss function based on the set of feature embedding outputs. In some embodiments, the method 800 may further comprise optimizing the deep learning backbone network by backpropagation of at least one of the first loss function, the second loss function and the third loss function.

Embodiments described herein may provide for accurate and enhanced performance in video classification and video retrieval tasks in a self-supervised manner. Embodiments described herein may further be applied to various video analysis systems, as may be appreciated by a person skilled in the art. Embodiments described herein may apply to video streaming analysis systems which require visual classification and lack sufficient training samples.

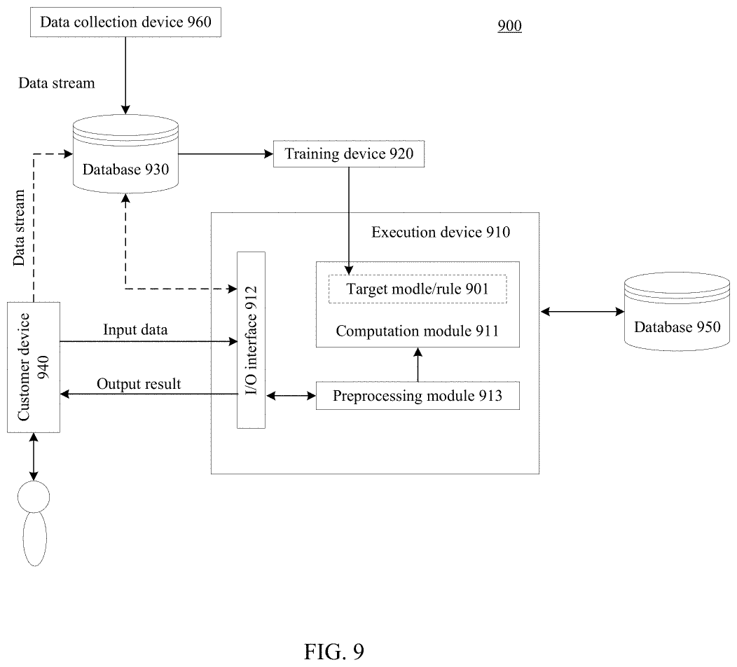

FIG. 9 is a schematic structural diagram of a system architecture according to an embodiment of the present disclosure. As shown in the system architecture 900, a data collection device 960 is configured to collect training data and store the training data into a database 930. The training data in this embodiment of this application includes for example the set of N videos or video sources, 301, represented by V={νᵢ}ᵢ₌₁^{N}. A training device 920 generates a target model/rule 901 based on the training data maintained in the database 930. The target model/rule 901 may refer to the trained model (e.g., model 320) having applied the training embodiments described herein, for example, embodiments described in reference to FIG. 6 and FIG. 8. Accordingly, the training device 920 may perform the model training as described in one or more embodiments described herein, for example, the embodiments described in reference to FIG. 6 and FIG. 8

Optionally, the one or more methods described herein may be processed by a CPU, or may be jointly processed by a CPU and a GPU, or may not be processed by a GPU, but processed by another processor that is applicable to neural network computation. This is not limited in this application.

The target model 901 (e.g., trained model 320) may be used for downstream tasks. A downstream task may be for example, a video classification task, which may be similar to an image classification task by replacing images with videos. In an embodiment, the input data to the model may be videos and the outputs may be predicted labels from the model. The predicted labels and the ground-truth labels may be used to obtain the classification loss, which is used to update the model parameters.

In some embodiments, the training data maintained in the database 930 is not necessarily collected by the data collection device 960, but may be obtained through reception from another device. it should be noted that the training device 920 does not necessarily perform the training (e.g., according to FIG. 6 and FIG. 8) with the target model/rule 901 fully based on the training data maintained by the database 930, but may perform model training on training data obtained from a cloud end or another place. The foregoing description shall not be construed as a limitation to this embodiment of the disclosure.

The target module/rule 901 obtained through training by the training device 920 may be applied to different systems or devices, for example, applied to an execution device 910. The execution device 910 may be a terminal, for example, a mobile terminal, a tablet computer, a notebook computer, AR/VR, or an in-vehicle terminal, or may be a server, a cloud end, or the like. The execution device 910 is provided with an I/O interface 912, which is configured to perform data interaction with an external device. A user may input data to the I/O interface 912 by using a customer device 940.

A preprocessing module 913 may be configured to perform preprocessing based on the input data (for example, one or more video sets) received from the I/O interface 912. For example, the input video segments may go through some preprocessing e.g., color jittering, random cropping, random resizing, etc.

In a related processing process in which the execution device 910 performs preprocessing on the input data or the computation module 911 in the execution device 110 performs computation, the execution device 910 may invoke data, code, or the like from a data storage system 950, to perform corresponding processing, or may store, in a data storage system 950, data, an instruction, or the like obtained through corresponding processing.

The I/O interface 912 may return a processing result to the customer device 940 and provides the processing result to the user. It should be noted that the training device 920 may generate a corresponding target model/rule 901 for different targets or different tasks (downstream tasks) based on different training data. The corresponding target model/rule 901 may be used to implement the foregoing target or accomplish the foregoing downstream tasks, to provide a desired result for the user.

In some embodiments, the user may manually specify input data by performing an operation on a screen provided by the I/O interface 912. In another case, the customer device 940 may automatically send input data to the I/O interface 912. If the customer device 940 needs to automatically send the input data, authorization of the user needs to be obtained. The user can specify a corresponding permission in the customer device 940. The user may view, in the customer device 940, the result output by the execution device 910. A specific presentation form may be display content, a voice, an action, and the like. In addition, the customer device 940 may be used as a data collector, to collect, as new sampling data, the input data that is input to the I/O interface 912 and the output result that is output by the I/O interface 912 that are shown in FIG. 1, and store the new sampling data into the database 930. The data may not be collected by the customer device 940, but the I/O interface 912 may directly store, as new sampling data into the database 930, the input data that is input to the I/O interface 912 and the output result that is output from the I/O interface 912.

It should be noted that FIG. 9 is merely a schematic diagram of a system architecture according to an embodiment of the present disclosure. Position relationships between the device, the component, the module, and the like that are shown do not constitute any limitation. For example, the data storage system 950 is an external memory relative to the execution device 910. In another case, the data storage system 950 may be located in the execution device 910.

As described herein, a convolutional neural network is a deep neural network with a convolutional structure, and is a deep learning (deep learning) architecture. The deep learning architecture indicates that a plurality of layers of learning is performed at different abstraction layers by using, for example, a machine learning algorithm. As a deep learning architecture, the CNN is a feed-forward (feed-forward) artificial neural network. Each neural cell in the feed-forward artificial neural network may respond to an input (e.g., image or video) to the neural cell.

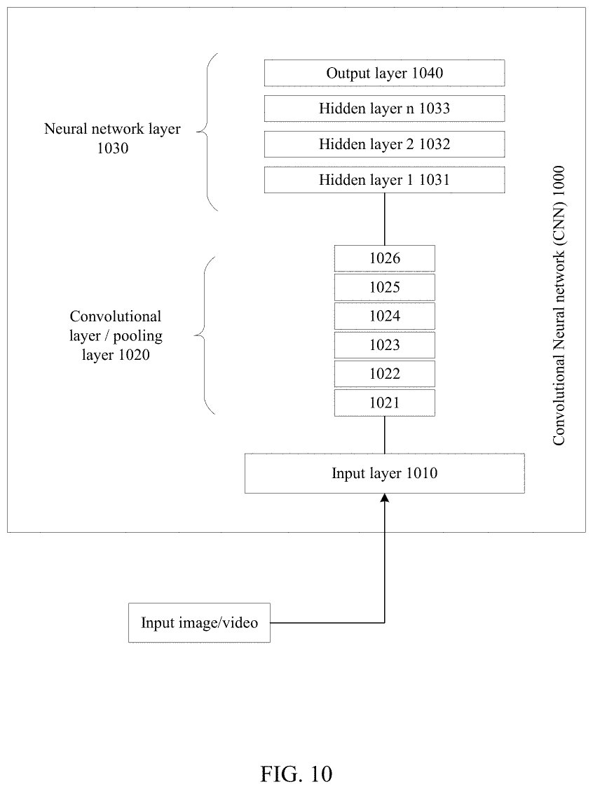

FIG. 10 illustrates a convolution neural network (CNN) according to an embodiment of the present disclosure. A CNN 1000 may include an input layer 1010, a convolutional layer/pooling layer 1020 (the pooling layer may be optional), and a neural network layer 1030.

The convolutional layer/pooling layer 1020 may include, for example, layers 1021 to 1026. In an embodiment, the layer 1021 is a convolutional layer, the layer 1022 is a pooling layer, the layer 1023 is a convolutional layer, the layer 1024 is a pooling layer, the layer 1025 is a convolutional layer, and the layer 1026 is a pooling layer. In another embodiment, the layers 1021 and 1022 are convolutional layers, the layer 1023 is a pooling layer, the layers 1024 and 1025 are convolutional layers, and the layer 1026 is a pooling layer. In other words, an output from a convolutional layer may be used as an input to a following pooling layer, or may be used as an input to another convolutional layer, to continue a convolution operation.

The internal operating principles of a convolutional layer is described in reference to convolutional layer 1021, for example. The convolutional layer 1021 may include a plurality of convolutional operators. The convolutional operator may be referred to as a kernel. A role of the convolutional operator in a video segment processing is equivalent to a filter that extracts specific information from a video segment matrix. In essence, the convolutional operator may be a weight matrix. The weight matrix is usually predefined. In a process of performing a convolution operation on a video segment, the weight matrix is applied to all the images (frames) in the video segment at the same time. It is usually processed one pixel after another (or two pixels after two pixels . . . , depending on a value of a stride (stride)) in a horizontal and vertical directions on the input video, to extract a specific feature from the video segment. A size of the weight matrix needs to be related to a size of the images of the video segment. It should be noted that a depth dimension (depth dimension) of the weight matrix is the same as a depth dimension of the input video segment. Therefore, after convolution is performed on a single weight matrix, convolutional output with a single depth dimension is output. However, the single weight matrix is not used in most cases, but a plurality of weight matrices with same dimensions (row×column) are used, e.g., a plurality of same-model matrices. Outputs of all the weight matrices are stacked to form the depth dimension of the convolutional output feature map. It can be understood that the dimension herein is determined by the foregoing “plurality”. Different weight matrices may be used to extract different features from the video segment. For example, one weight matrix is used to extract object edge information, another weight matrix is used to extract a specific color of the video, still another weight matrix is used to blur unneeded noises from the video, and so on. The plurality of weight matrices have a same size (row×column). Feature graphs obtained after extraction performed by the plurality of weight matrices with the same dimension also have a same size, and the plurality of extracted feature graphs with the same size are combined to form an output of the convolution operation.

Weight values in weight matrices may be obtained through training. The weight matrices formed by the weight values obtained through training may be used to extract information from the input image, so that the convolutional neural network 1000 performs accurate prediction.

When the convolutional neural network 1000 has a plurality of convolutional layers, an initial convolutional layer (such as 1021) usually extracts a relatively large quantity of common features. The common feature may also be referred to as a low-level feature. As a depth of the convolutional neural network 1000 increases, a feature extracted by a deeper convolutional layer (such as 1026) becomes more complex, for example, a feature with high-level semantics or the like. A feature with higher-level semantics is more applicable to a to-be-resolved problem.

Because a quantity of training parameters usually needs to be reduced, a pooling layer usually needs to periodically follow a convolutional layer. For example, at the layers 1021 to 1026, one pooling layer may follow one convolutional layer, or one or more pooling layers may follow a plurality of convolutional layers. The pooling layer may be used to reduce a spatial or temporal size of feature maps (e.g., in a video processing process). The pooling layer may include an average pooling operator and/or a maximum pooling operator, to perform sampling on the input feature map to obtain an output feature map of a relatively small size. The average pooling operator may calculate a pixel value in the input feature map within a specific range, to generate an average value as an average pooling result. The maximum pooling operator may obtain, as a maximum pooling result, a pixel with a largest value within the specific range. In addition, just like the size of the weight matrix in the convolutional layer needs to be related to the size of the feature map, an operator at the pooling layer also needs to be related to the size of the feature map. The size of the output feature map after processing by the pooling layer may be smaller than a size of the input feature map to the pooling layer. Each pixel in the output feature map by the pooling layer indicates an average value or a maximum value of a subarea corresponding to the input feature map to the pooling layer.

After the video segment is processed by the convolutional layer/pooling layer 1020, the convolutional neural network 1000 may still be incapable of outputting a desired information. The convolutional layer/pooling layer 1020 may only extract a feature, and reduce a parameter brought by the input video segment. However, to generate final output information (desired category information or other related information), the convolutional neural network 1000 may need to generate an output of a quantity of one or a group of desired categories by using the neural network layer 1030. Therefore, the neural network layer 1030 may include a plurality of hidden layers (such as 1031, 1032, to 1033 (represent n^{th} hidden layer)) and an output layer 1040. A parameter included in the plurality of hidden layers may be obtained by performing pre-training based on related training data of a specific downstream task type. For example, the task type may include video recognition or the like.

The output layer 1040 follows the plurality of hidden layers in the neural network layers 1030. The output layer 1040 is a final layer in the entire convolutional neural network 1000. The output layer 1040 may have a loss function similar to category cross-entropy and is used to calculate a prediction error. Once forward propagation (propagation in a direction from 1010 to 1040 is forward propagation) is complete in the entire convolutional neural network 1000, back propagation (propagation in a direction from 1040 to 1010 is back propagation) starts to update the weight values and offsets of the foregoing layers, to reduce a loss of the convolutional neural network 1000 and an error between an ideal result and a result output by the convolutional neural network 1000 by using the output layer.

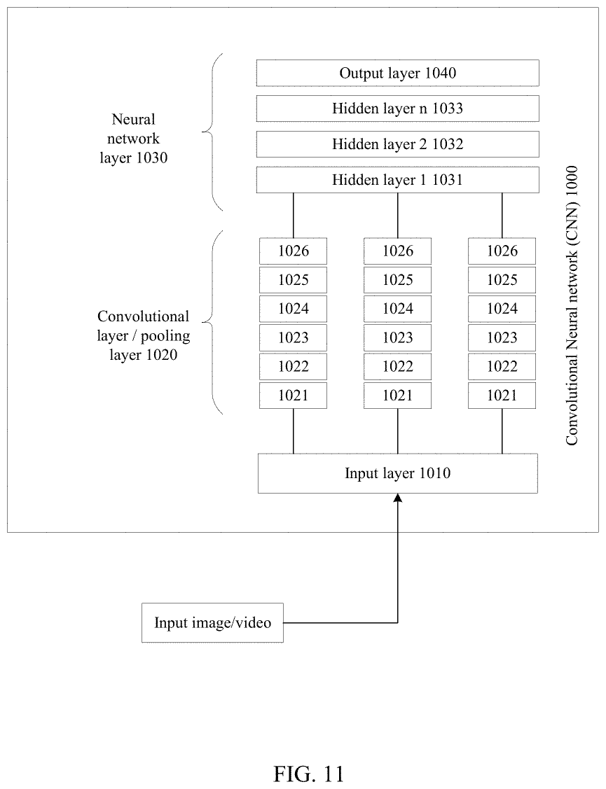

It should be noted that the convolutional neural network 1000 is merely used as an example of a convolutional neural network. In actual application, the convolutional neural network may exist in a form of another network model. For example, a plurality of convolutional layers/pooling layers shown in FIG. 11 are parallel, and separately extracted features are all input to the neural network layer 1030 for processing.

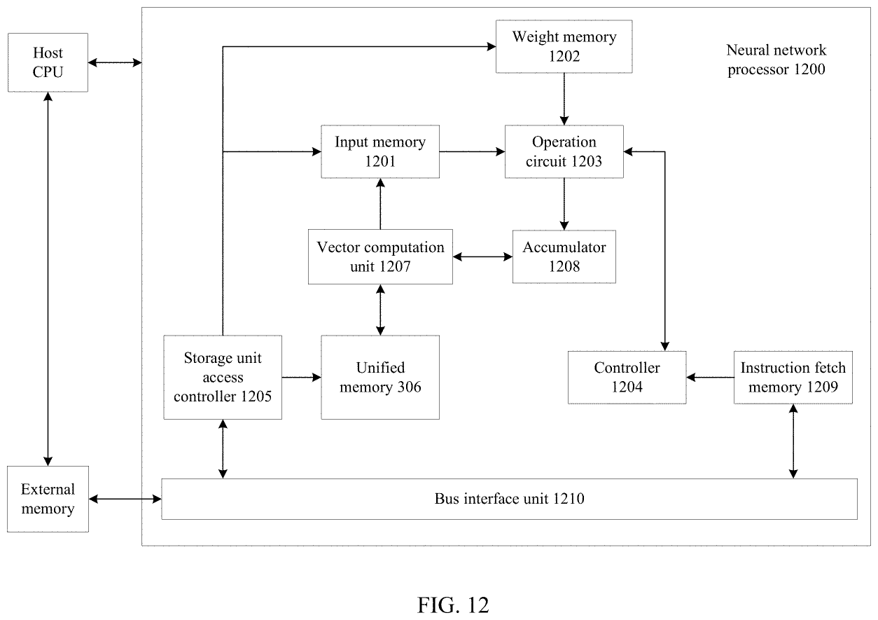

FIG. 12 illustrates a schematic diagram of a hardware structure of a chip according to an embodiment of the present disclosure. The chip includes a neural network processor 1230. The chip may be provided in the execution device 910 shown in FIG. 9, to perform computation for the computation module 911. Alternatively, the chip may be provided in the training device 920 shown in FIG. 9, to perform training and output the target model/rule 901. All the algorithms of layers of the convolutional neural network shown in FIG. 10 and FIG. 11 may be implemented in the chip shown in FIG. 12.

The neural network processor 1230 may be any processor that is applicable to massive exclusive OR operations, for example, an NPU, a TPU, a GPU, or the like. The NPU is used as an example. The NPU may be mounted, as a coprocessor, to a host CPU, and the host CPU may allocate a task to the NPU. A core part of the NPU is an operation circuit 1203. A controller 1204 controls the operation circuit 1203 to extract matrix data from memories (1201 and 1202) and perform multiplication and addition operations.

In some implementations, the operation circuit 1203 internally includes a plurality of processing units (e.g., Process Engine, PE). In some implementations, the operation circuit 1203 is a bi-dimensional systolic array. In addition, the operation circuit 1203 may be a unidimensional systolic array or another electronic circuit that can implement a mathematical operation such as multiplication and addition. In some implementations, the operation circuit 1203 is a general matrix processor.

For example, it is assumed that there are an input matrix A, a weight matrix B, and an output matrix C. The operation circuit 1203 may obtain, from a weight memory 1202, weight data of the matrix B, and cache the data in each PE in the operation circuit 1203. The operation circuit 1203 may obtain input data of the matrix A from an input memory 1201, and perform a matrix operation based on the input data of the matrix A and the weight data of the matrix B. An obtained partial or final matrix result may be stored in an accumulator (accumulator) 1208.

A unified memory 1206 may be configured to store input data and output data. Weight data may be directly moved to the weight memory 1202 by using a storage unit access controller (e.g., Direct Memory Access Controller, DMAC) 1205. The input data may also be moved to the unified memory 1206 by using the DMAC.

A bus interface unit (BIU) 1210 may be used for interaction between the storage unit access controller (e.g., DMAC) 1205 and an instruction fetch memory (Instruction Fetch Buffer) 1209. The bus interface unit 1210 may further be configured to enable the instruction fetch memory 1209 to obtain an instruction from an external memory. The BIU 1210 may further be configured to enable the storage unit access controller 1205 to obtain, from the external memory, source data of the input matrix A or the weight matrix B.

The storage unit access controller (e.g., DMAC) 1205 is mainly configured to move input data from an external memory DDR to the unified memory 1206, or move the weight data to the weight memory 1202, or move the input data to the input memory 1201.

A vector computation unit 1207 may include a plurality of operation processing units. If needed, the vector computation unit 307 may perform further processing, for example, vector multiplication, vector addition, an exponent operation, a logarithm operation, or magnitude comparison, on an output from the operation circuit 1203. The vector computation unit 1207 may be used for computation at a non-convolutional layer or fully-connected layers (FC, fully connected layers) of a neural network. The vector computation unit 1207 may further perform processing on computation such as pooling (pooling) or normalization (normalization). For example, the vector computation unit 1207 may apply a nonlinear function to an output of the operation circuit 1203, for example, a vector of an accumulated value, to generate an activation value. In some implementations, the vector computation unit 1207 may generate a normalized value, a combined value, or both a normalized value and a combined value.

In some implementations, the vector computation unit 1207 may store a processed vector to the unified memory 1206. In some implementations, the vector processed by the vector computation unit 1207 may be used as activation input to the operation circuit 1203, for example, to be used in a following layer of the neural network. As shown in FIG. 10, if a current processing layer is a hidden layer 1 (1031), a vector processed by the vector computation unit 1207 may be used for computation of a hidden layer 2 (1032).

The instruction fetch memory (instruction fetch buffer) 1209 connected to the controller 1204 may be configured to store an instruction used by the controller 1204. The unified memory 1206, the input memory 1201, the weight memory 1202, and the instruction fetch memory 1209 may all be on-chip memories. The external memory may be independent from the hardware architecture of the NPU.

Operations of all layers of the convolutional neural network shown in FIG. 10 and FIG. 11 may be performed by the operation circuit 1203 or the vector computation unit 1207.

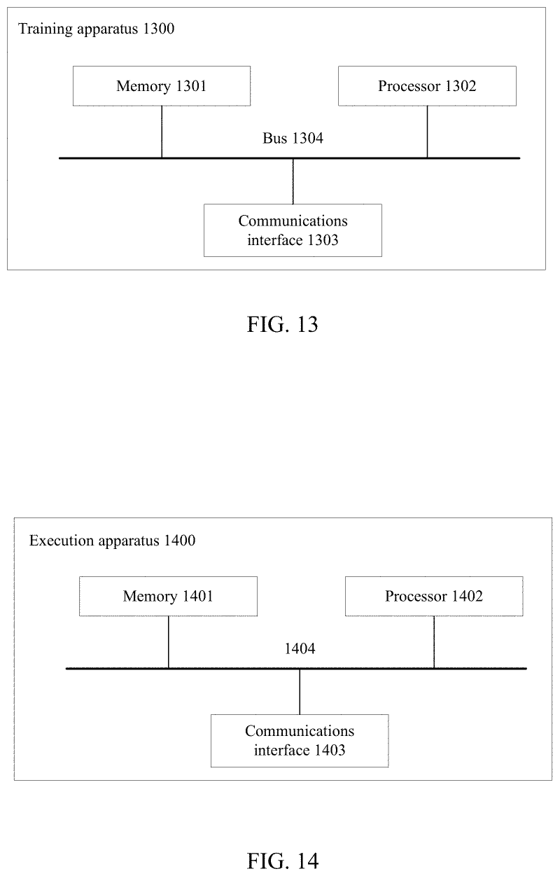

FIG. 13 illustrates a schematic diagram of a hardware structure of a training apparatus according to an embodiment of the present disclosure. A training apparatus 1300 (the apparatus 1300 may be a computer device and may refer to the training device 920) may include a memory 1301, a processor 1302, a communications interface 1303, and a bus 1304. A communication connection is implemented between the memory 1301, the processor 1302, and the communications interface 1303 by using the bus 1304.

The memory 1301 may be a read-only memory (Read Only Memory, ROM), a static storage device, a dynamic storage device, or a random-access memory (Random Access Memory, RAM). The memory 1301 may store a program. The processor 1302 and the communications interface 1303 may be configured to perform, when the program stored in the memory 1301 is executed by the processor 1302, steps of one or more embodiments described herein, for example, embodiments described in reference to FIG. 6 and FIG. 8.

The processor 1302 may be a general central processing unit (Central Processing Unit, CPU), a microprocessor, an application-specific integrated circuit (Application Specific Integrated Circuit, ASIC), a graphics processing unit (graphics processing unit, GPU), or one or more integrated circuits. The processor 1302 may be configured to execute a related program to implement a function that needs to be performed by a unit in the training apparatus according to one or more embodiments described herein, for example, embodiments described in reference to FIG. 6 and FIG. 8

In addition, the processor 1302 may be an integrated circuit chip with a signal processing capability. In an implementation process, steps of one or more training methods described herein may be performed by an integrated logical circuit in a form of hardware or by an instruction in a form of software in the processor 1302. In addition, the foregoing processor 1302 may be a general-purpose processor, a digital signal processor (Digital Signal Processor, DSP), an application-specific integrated circuit (ASIC), a field programmable gate array (Field Programmable Gate Array, FPGA) or another programmable logic device, a discrete gate or a transistor logic device, or a discrete hardware assembly. The processor 1302 may implement or execute the methods, steps, and logical block diagrams that are disclosed in the embodiments of this disclosure. The general-purpose processor may be a microprocessor, or the processor may be any conventional processor or the like. The steps of the method disclosed with reference to the embodiments of this disclosure may be directly performed by a hardware decoding processor, or may be performed by using a combination of hardware in the decoding processor and a software module. The software module may be located in a mature storage medium in the art, such as a random-access memory, a flash memory, a read-only memory, a programmable read-only memory, an electrically erasable programmable memory, or a register. The storage medium may be located in the memory 1301. The processor 1302 may read information from the memory 1301, and completes, by using hardware in the processor 1302, the functions that need to be performed by the units included in the training apparatus according to one or more embodiment described herein, for example, embodiments described in reference to FIG. 6 and FIG. 8.

The communications interface 1303 may implement communication between the apparatus 1300 and another device or communications network by using a transceiver apparatus, for example, including but not limited to a transceiver. For example, training data (for example, one or more sets of videos) may be obtained by using the communications interface 1303.

The bus 1304 may include a path that transfers information between all the components (for example, the memory 1301, the processor 1302, and the communications interface 1303) of the apparatus 1300.

FIG. 14 illustrates a schematic diagram of a hardware structure of an execution apparatus according to an embodiment of the present disclosure. The execution apparatus may refer to the execution device 910 of FIG. 9. Execution apparatus 1400 (which may be a computer device) includes a memory 1401, a processor 1402, a communications interface 1403, and a bus 1404. A communication connection is implemented between the memory 1401, the processor 1402, and the communications interface 1403 by using the bus 1404.

The memory 1401 may be a read-only memory (Read Only Memory, ROM), a static storage device, a dynamic storage device, or a random-access memory (Random Access Memory, RAM). The memory 1401 may store a program. The processor 1402 and the communications interface 1403 are configured to perform, when the program stored in the memory 1401 is executed by the processor 1402, one or more downstream tasks.

The processor 1402 may be a general central processing unit (Central Processing Unit, CPU), a microprocessor, an application-specific integrated circuit (Application Specific Integrated Circuit, ASIC), a graphics processing unit (graphics processing unit, GPU), or one or more integrated circuits. The processor 1402 may be configured to execute a related program to perform one or more downstream tasks.

In addition, the processor 1402 may be an integrated circuit chip with a signal processing capability. In an implementation process, steps of one or more downstream tasks may be performed by an integrated logical circuit in a form of hardware or by an instruction in a form of software in the processor 1402. In addition, the processor 1402 may be a general-purpose processor, a digital signal processor (Digital Signal Processor, DSP), an application-specific integrated circuit (ASIC), a field programmable gate array (Field Programmable Gate Array, FPGA) or another programmable logic device, a discrete gate or a transistor logic device, or a discrete hardware assembly. The general-purpose processor may be a microprocessor, or the processor may be any conventional processor or the like. The one or more downstream tasks may be directly performed by a hardware decoding processor, or may be performed by using a combination of hardware in the decoding processor and a software module. The software module may be located in a mature storage medium in the art, such as a random-access memory, a flash memory, a read-only memory, a programmable read-only memory, an electrically erasable programmable memory, or a register. The storage medium may be located in the memory 1401. The processor 1402 may read information from the memory 1401, and completes, by using hardware in the processor 1402, to perform one or more downstream tasks as described herein.

The communications interface 1403 may implement communication between the apparatus 1400 and another device or communications network by using a transceiver apparatus, for example, including but not limited to a transceiver. For example, training data for one or more downstream tasks may be obtained by using the communications interface 1403.

The bus 1404 may include a path that transfers information between all the components (for example, the memory 1401, the processor 1402, and the communications interface 1403) of the apparatus 1400.

It should be noted that, although only the memory, the processor, and the communications interface are shown in the apparatuses 1300 (in FIG. 13) and 1400 (in FIG. 14), a person skilled in the art should understand that the apparatuses 1300 and 1400 may further include other components that are necessary for implementing normal running. In addition, based on specific needs, a person skilled in the art should understand that the apparatuses 1300 and 1400 may further include hardware components that implement other additional functions. In addition, a person skilled in the art should understand that the apparatuses 1300 and 1400 may include only a component required for implementing the embodiments of the present disclosure, without a need to include all the components shown in FIG. 13 or FIG. 14.

It may be understood that the apparatus 1300 is equivalent to the training device 920 in FIG. 9, and the apparatus 1400 is equivalent to the execution device 910 in FIG. 9. A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

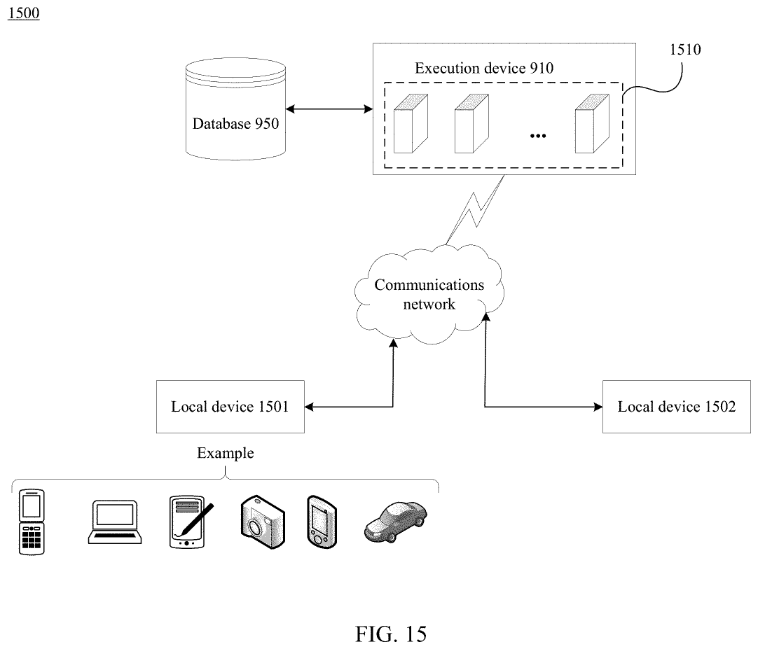

FIG. 15 illustrates a system architecture according to an embodiment of the present disclosure. The execution device 910 may be implemented by one or more servers 1510, and optionally, supported by another computation device, for example, a data memory, a router, a load balancer, or another device. The execution device 910 may be arranged in a physical station or be distributed to a plurality of physical stations. The execution device 910 may use data in a data storage system 950 or invoke program code in a data storage system 950, to implement one or more downstream tasks.

Users may operate respective user equipment (such as a local device 1501 and a local device 1502) of the users to interact with the execution device 910. Each local device may indicate any computation device, for example, a personal computer, a computer work station, a smartphone, a tablet computer, a smart camera, a smart car, or another type of cellular phone, a media consumption device, a wearable device, a set-top box, or a game console.

The local device of each user may interact with the execution device 910 by using a communications network of any communications mechanism/communications standard. The communications network may be a wide area network, a local area network, a point-to-point connected network, or any combination thereof.

In another implementation, one or more aspects of the execution devices 910 may be implemented by each local device. For example, the local device 1501 may provide local data for the execution device 910 or feedback a computation result.

It should be noted that all functionalities of the execution device 910 may be implemented by the local device. For example, the local device 1501 may implement a function of the execution device 910 and provides a service for a user of the local device 1501, or provides a service for a user of the local device 1502.

It may be understood by a person skilled in the art that, for the purpose of convenient and brief description, for a detailed working process of the foregoing system, apparatus, and unit, refer to one or more corresponding embodiments described herein, and details are not described herein again.

In the several embodiments provided in this application, it should be understood that the disclosed system, apparatus, and method may be implemented in other manners. For example, the described apparatus embodiment is merely an example. For example, a plurality of units or components may be combined or integrated into another system, or some features may be ignored or not performed. In addition, the displayed or discussed communication connections may be implemented by using some interfaces. The indirect communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present disclosure, or the part contributing to the prior art, or some of the technical solutions may be implemented in a form of a software product. The software product may be stored in a storage medium, and includes several instructions for instructing a computer device (which may be a personal computer, a server, or a network device) to perform all or some of the steps of the methods described in the embodiments of this application. The foregoing storage medium includes any medium that can store program code, such as a USB flash drive, a removable hard disk, a read-only memory (Read-Only Memory, ROM), a random-access memory (Random Access Memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method comprising:
feeding a primary video segment, representative of a concatenation of a first and a second nonadjacent video segments obtained from a video source, to a deep learning backbone network;
embedding, via the deep learning backbone network, the primary video segment into a first feature output;
providing the first feature output to a first perception network to generate a first set of probability distribution outputs indicating a temporal location of a discontinuous point associated with the primary video segment;
generating a first loss function based on the first set of probability distribution outputs; and
optimizing the deep learning backbone network, by backpropagation of the first loss function.

2. The method of claim 1 further comprising:
feeding a third video segment, nonadjacent to each of the first video segment and second video segment, obtained from the video source, to the deep learning backbone network;
embedding, via the deep learning backbone network, the third video segment into a second feature output; and
providing the first feature output and the second feature output to a second perception network to generate a second set of probability distribution outputs indicating one or more of a continuity probability and a discontinuity probability associated with the primary and the third video segments;
generating a second loss function based on the second set of probability distribution outputs; and
optimizing the deep learning backbone network, by backpropagation of at least one of the first loss function and the second loss function.

3. The method of claim 2 further comprising:
feeding a fourth video segment, obtained from the video source and temporally adjacent to the first and the second video segments, to the deep learning backbone network;
embedding, via the deep learning backbone network, the fourth video segment into a third feature output;
providing the first feature output, the second feature output, and the third feature output to a projection network to generate a set of feature embedding outputs comprising:
a first feature embedding output associated with the primary video segment;
a second feature embedding output associated with the third video segment; and
a third feature embedding output associated with the fourth video segment.
generating a third loss function based on the set of feature embedding outputs; and
optimizing the deep learning backbone network by backpropagation of at least one of the first loss function, the second loss function and the third loss function.

4. The method of claim 3, wherein:
each of the primary video segment and the third video segment is of length n frames, n being an integer equal or greater than two.

5. The method of claim 3 wherein the fourth video segment is of length m frames, m being an integer equal or greater than one.

6. The method of claim 1, wherein the deep learning backbone network is a 3-dimensional convolution network.

7. The method of claim 2, wherein each of the first perception network and the second perception network is a multi-layer perception network.

8. The method of claim 3, wherein the projection network is a light-weight convolutional network comprising one or more of: a 3-dimensional convolution layer, an activation layer, and an average pooling layer.

9. The method of claim 1, wherein the video source suggests a smooth translation of content and motion across consecutive frames.

10. The method of claim 3, wherein:
the first loss functions is
$${ℒ}_{j} ( V ; {θ}_{f} , {θ}_{j} ) = - \frac{1}{n} {\sum }_{i}^{n} [ log ( {J ( {f}_{i , d} )}_{y = 0} ) + log ( {J ( {f}_{i , c} )}_{y = 1} ) ] ;$$
the second loss functions is:
$${ℒ}_{l} ( V ; {θ}_{f} , {θ}_{l} ) = - \frac{1}{n} {\sum }_{i}^{n} log \frac{exp ( {L ( {f}_{i , d} )}_{y} )}{{\sum }_{Y} exp ( L ( {f}_{i , d} ) )} ;$$
the third loss function is:
$${ℒ}_{r} ( V ; {θ}_{f} , {θ}_{r} ) = - \frac{1}{n} {\sum }_{i}^{n} [ log \frac{exp ( \frac{sim ( {e}_{i , d} , {e}_{i , c} )}{τ} )}{{\sum }_{j = 0}^{N} exp ( \frac{sim ( {e}_{i , d} , {e}_{j , c} )}{τ} )} + ω * max ( 0 , γ - ( sim ( {e}_{i , d} , {e}_{i , m} ) - sim ( {e}_{i , d} , {e}_{i , c} ) ) ) ]$$
and wherein:
V is a set of video sources, wherein the video source is from the set of video sources:
θ_{f} is one or more weight parameters associated with the deep learning backbone network;
θₗ is one or more weight parameters associated with the first perception network;
θⱼ is one or more weight parameters associated with the second perception network;
θᵣ is one or more weight parameters associated with the projection network;
J(fᵢ) represents the second set of probability distribution outputs;
L(fᵢ) represents the first set of probability distribution outputs;
eᵢ represents the set of feature embedding outputs from the projection network;
e_{j,c} represents one feature embedding output of a video segment obtained from a second video source different from the video source;
sim(.,.) represents a similarity score between two feature embedding outputs of the set of feature embedding outputs; and
τ, γ and ω are hyper-parameters.

11. An apparatus comprising:
at least one processor; and
at least one machine-readable medium storing executable instructions which when executed by the at least one processor configure the apparatus for:
feeding a primary video segment, representative of a concatenation of a first and a second nonadjacent video segments obtained from a video source, to a deep learning backbone network;
embedding, via the deep learning backbone network, the primary video segment into a first feature output;
providing the first feature output to a first perception network to generate a first set of probability distribution outputs indicating a temporal location of a discontinuous point associated with the primary video segment;
generating a first loss function based on the first set of probability distribution outputs; and
optimizing the deep learning backbone network, by backpropagation of the first loss function.

12. The apparatus of claim 11, wherein the executable instructions which when executed by the at least one processor further configure the apparatus for:
feeding a third video segment, nonadjacent to each of the first video segment and second video segment, obtained from the video source, to the deep learning backbone network;
embedding, via the deep learning backbone network, the third video segment into a second feature output; and
providing the first feature output and the second feature output to a second perception network to generate a second set of probability distribution outputs indicating one or more of a continuity probability and a discontinuity probability associated with the primary and the third video segments;
generating a second loss function based on the second set of probability distribution outputs; and
optimizing the deep learning backbone network, by backpropagation of at least one of the first loss function and the second loss function.

13. The apparatus of claim 12, wherein the executable instructions which when executed by the at least one processor further configure the apparatus for:
feeding a fourth video segment, obtained from the video source and temporally adjacent to the first and the second video segments, to the deep learning backbone network;
embedding, via the deep learning backbone network, the fourth video segment into a third feature output; and
providing the first feature output, the second feature output, and the third feature output to a projection network to generate a set of feature embedding outputs comprising:
a first feature embedding output associated with the primary video segment;
a second feature embedding output associated with the third video segment; and
a third feature embedding output associated with the fourth video segment;
generating a third loss function based on the set of feature embedding outputs; and
optimizing the deep learning backbone network by backpropagation of at least one of the first loss function, the second loss function and the third loss function.

14. The apparatus of claim 13, wherein:
each of the primary video segment and the third video segment is of length n frames;
the fourth video segment is of length m frames;
n is an integer equal or greater than two; and
m is an integer equal or greater than one.

15. The apparatus of claim 11, wherein the deep learning backbone network is a 3-dimensional convolution network.

16. The apparatus of claim 12, wherein each of the first perception network and the second perception network is a multi-layer perception network.

17. The apparatus of claim 13, wherein the projection network is a lightweight convolutional network, which is composed of a 3-dimensional convolution layer, an activation layer, and an average pooling layer.

18. The apparatus of claim 11, wherein the video source suggests a smooth translation of content and motion across consecutive frames.

19. The apparatus of claim 13, wherein
the first loss functions is:
$${ℒ}_{j} ( V ; {θ}_{f} , {θ}_{j} ) = - \frac{1}{n} {\sum }_{i}^{n} [ log ( {J ( {f}_{i , d} )}_{y = 0} ) + log ( {J ( {f}_{i , c} )}_{y = 1} ) ] ;$$
the second loss functions is:
$${ℒ}_{l} ( V ; {θ}_{f} , {θ}_{l} ) = - \frac{1}{n} {\sum }_{i}^{n} log \frac{exp ( {L ( {f}_{i , d} )}_{y} )}{{\sum }_{Y} exp ( L ( {f}_{i , d} ) )} ;$$
the third loss function is:
$${ℒ}_{r} ( V ; {θ}_{f} , {θ}_{r} ) = - \frac{1}{n} {\sum }_{i}^{n} [ log \frac{exp ( \frac{sim ( {e}_{i , d} , {e}_{i , c} )}{τ} )}{{\sum }_{j = 0}^{N} exp ( \frac{sim ( {e}_{i , d} , {e}_{j , c} )}{τ} )} + ω * max ( 0 , γ - ( sim ( {e}_{i , d} , {e}_{i , m} ) - sim ( {e}_{i , d} , {e}_{i , c} ) ) ) ]$$
and wherein:
V is a set of video sources, wherein the video source is from the set of video sources:
θ_{f} is one or more weight parameters associated with the deep learning backbone network;
θ₁ is one or more weight parameters associated with the first perception network;
θⱼ is one or more weight parameters associated with the second perception network;
θᵣ is one or more weight parameters associated with the projection network;
J(fᵢ) represents the second set of probability distribution outputs;
L(fᵢ) represents the first set of probability distribution outputs;
eᵢ represents the set of feature embedding outputs from the projection network;
e_{j,c} represents one feature embedding output of a video segment obtained from a second video source different from the video source; and
sim(.,.) represents a similarity score of between two feature embedding outputs of the set of feature embedding outputs; and
τ, γ and ω are hyper-parameters.

20. A non-transitory computer-readable medium storing executable instructions which when executed by a processor of a device configure the device for:
feeding a primary video segment, representative of a concatenation of a first and a second nonadjacent video segments obtained from a video source, to a deep learning backbone network;
embedding, via the deep learning backbone network, the primary video segment into a first feature output;
providing the first feature output to a first perception network to generate a first set of probability distribution outputs indicating a location of a discontinuous point associated with the primary video segment;
generating a first loss function based on the first set of probability distribution outputs; and
optimizing the deep learning backbone network, by backpropagation of the first loss function.
